(19) United States
(12) Patent Application Publication
(10) Pub. No.: US 2025/0357717 A1
(43) Pub. Date: Nov. 20, 2025

(54) SAPPHIRE OPTICAL WAVEGUIDE BASED GAIN MEDIUM

(71) Applicant: Oxford University Innovation Limited, Oxford (GB)

(72) Inventor: Julian FELLS, Oxford (Oxfordshire) (GB)

(21) Appl. No.: 18/871,627

(22) PCT Filed: Jun. 8, 2023
(86) PCT No.: PCT/GB2023/051496

§ 371 Date: Dec. 4, 2024

(30) Foreign Application Priority Data
Jun. 9, 2022 (GB) 2208491.7
Sep. 23, 2022 (GB) 2213940.6

(51) Int. Cl. H01S 3/08045; H01S 3/067; H01S 3/094; H01S 3/16

(52) U.S. Cl. CPC H01S 3/08045; H01S 3/06733; H01S 3/06741; H01S 3/0675; H01S 3/06754; H01S 3/094038; H01S 3/1636; H01S 3/1618; H01S 3/1623; H01S 3/1625

(57) ABSTRACT

A method of stimulating emission of light comprising using a single-mode sapphire optical waveguide as a gain medium, and a sapphire optical device comprising an optical gain medium comprising a single-mode sapphire optical waveguide.

The invention relates to a method of stimulating emission of light, and to a sapphire optical device and method.

Doped optical fibres can be used to provide optical gain and also laser light. However, typically the optical fibres are made of silica which has disadvantages in certain circumstances. Firstly, silica is absorbing at certain wavelengths, particularly in the mid-infra red, which is an important waveband for spectroscopy. A further disadvantage is that they can degenerate when subjected to radiation. This is a problem for applications such as use in space or use in nuclear reactors for example.

An important class of laser is the titanium doped sapphire laser (Ti:sapphire). These laser allow ultra-short pulse generation and have very wide gain bandwidths e.g. allowing a very wide range of laser wavelengths to be accessed and wide tunability. However, Ti:sapphire lasers can be bulky and expensive. Another issue is that the interaction lengths are relatively short because light will rapidly diverge, which limits the amount of optical gain available.

The pump absorption length of titanium doped sapphire is relatively large, while the product of the emission-cross-section and upper laser level lifetime is relatively small. A small upper laser level lifetime means that small laser and pump mode radii are required to keep the threshold pump power for the titanium doped sapphire laser reasonable. In bulk titanium doped sapphire lasers, this means the pump and laser will diverge rapidly from the focus. This means that it is difficult to keep the mode radii small over the length of the titanium doped sapphire crystal required to absorb the pump efficiently. This typically results in requiring high spatial brightness frequency doubled Nd-based lasers as the pump for titanium doped sapphire, which can be expensive e.g. around 10,000 £/W. Some blue diode lasers are substantially less than this (e.g. at around 100 £/W), but it is difficult to use such blue diode lasers to pump titanium doped sapphire.

In general, improvements in gain media for lasers and optical amplifiers are desirable. For example, there is a need to improve the gain limitations, absorption length drawbacks and cost of bulk titanium doped sapphire.

The invention provides an apparatus and method for providing optical gain and laser light which overcomes limitations such as those above.

According to a first aspect of the invention there is provided a method of stimulating emission of light, comprising using a single-mode sapphire optical waveguide as a gain medium.

The method therefore comprises stimulating the emission of light in the single-mode sapphire optical waveguide, and hence the waveguide serves as a source of optical gain. This can have various applications, for example the method may comprise using the single-mode sapphire optical waveguide as part of an optical amplifier for amplifying an optical signal. The method may comprise using the single-mode sapphire optical waveguide as part of a laser system for generating laser light. In use, the gain medium (also called a lasing medium, laser medium, active laser medium, and so on) therefore transfers energy as emitted electromagnetic radiation (i.e. light). The method may therefore be a method of amplifying and/or generating light.

The single-mode sapphire optical waveguide may be within an optical device such as an optical fibre, or may be within a block or rod of sapphire. The single-mode sapphire optical waveguide may be within a sapphire optical fibre. The single-mode sapphire optical waveguide may therefore be part of the optical fibre. The method may therefore comprise providing a sapphire optical fibre comprising a single-mode sapphire optical waveguide, and using the fibre—and specifically the single-mode waveguide therein—as a gain medium e.g. of an optical amplifier and/or of a laser. Thought of another way, the single-mode sapphire optical waveguide may comprise an optical core of the sapphire optical fibre (co-operating with a suitable boundary e.g. provided by laser-fabricated cladding within the fibre).

By the provision of the single-mode sapphire optical waveguide within the sapphire optical fibre, the fibre itself may be considered to be a ‘single-mode fibre’, but it will be appreciated that it is the single-mode waveguide that makes the fibre ‘single-mode’in that sense, since it is within the single-mode waveguide that light propagation is constrained to a single mode. The rest of the fibre (i.e. the portion of the fibre other than the single-mode waveguide) may therefore not be single-mode. The rest of the fibre may be multimode, and may therefore support multiple propagation modes therein, whereas the single-mode waveguide supports only a single propagation mode. The rest of the fibre may comprise cladding, modified regions (e.g. laser-modified regions, etched regions, and so on), bulk sapphire, and so on.

A method for manufacturing a single-mode sapphire optical fibre was disclosed in patent application GB1712640.0, the contents of which are hereby incorporated in their entirety. The inventor has discovered that the methods and features disclosed therein may be combined with features to the present invention. A single-mode sapphire optical waveguide may be created within a sapphire optical fibre by laser modifying the fibre. However, since sapphire has a relatively high refractive index (e.g. of approximately 1.75), focusing within such a fibre is subject to significant aberrations and therefore the precision and accuracy of laser-modification is limited by that aberration. However, as recognized in GB1712640.0, a correction may be determined and applied to the modifying laser (e.g. using an active optical element to modify its wavefront properties) to counteract the aberrating effects of the fibre on the laser focus therein. By counteracting those aberrating effects of the fiber, accurate and precise laser modification of the fibre is made possible on length scales and in materials the use of which were previously not possible. The method may therefore comprise inscribing structures with femtosecond laser direct writing, using adaptive beam shaping with a non-immersion objective. Alternatively, the method may comprise using an immersion objective and/or immersion oil, and may comprise e.g. inscribing structures with femtosecond laser direct writing using adaptive beam shaping with an immersion objective and immersion oil. Other methods of manufacturing a single-mode sapphire optical fibre may also be possible now, for example by etching, index matching, and so on.

The method may comprise laser modifying the optical fibre (e.g. a sapphire optical fibre) to form the single-mode sapphire optical waveguide at a target location within the fibre. The laser modification may configure the waveguide and/or the fibre to prevent, suppress or reduce propagation of a plurality of optical modes therein.

The method may comprise positioning at least a portion of the optical fibre in a laser system for modification by a laser; and laser modifying the optical fibre at the target location using the laser so as to produce the waveguide.

The method may comprise applying a correction to an active optical element of the laser system to modify wavefront properties of the laser to counteract an effect of aberration on laser focus caused by the fibre. The method may comprise laser modifying the optical fibre at the target location using the laser with the corrected wavefront properties to thereby produce the waveguide.

The single-mode sapphire optical waveguide may be formed in the sapphire optical fibre by a laser modified region of the sapphire optical fibre. The optical fibre may therefore be laser modified to prevent or reduce the propagation of higher-order modes therein. The method may comprise fabricating the single-mode waveguide by laser modifying a sapphire optical fibre (e.g. a multimode sapphire optical fibre) to form therein the single-mode sapphire optical waveguide.

Laser-modification of sapphire can change the physical properties of the modified region e.g. by changing its refractive index, size, density, uniformity, homogeneity, and so on. The method may comprise directly modifying a portion of the sapphire optical fibre to create the waveguide e.g. by modifying properties of an optical core of the fibre to directly form the waveguide thereby.

The method may comprise modifying regions surrounding a portion of the fibre to create e.g. a strain field on that portion and thereby change its optical properties and hence turn the portion into an optical core (e.g. a single-mode waveguide) with desired properties, albeit a core that has not itself been directly modified using the laser.

The method may comprise modifying regions surrounding the portion of the fibre so that the modified regions have a different refractive index (e.g. a reduced refractive index) compared to the portion they surround, thereby effectively forming cladding surrounding an unmodified optical core of the fibre. In effect, the method may comprise laser-modifying a portion of the optical fibre to create cladding about an unmodified core of the fibre, to thereby provide the single-mode waveguide. The method may comprise modifying (e.g. laser-modifying) the fibre to fabricate a depressed cladding waveguide therein.

A waveguide typically comprises an optical core within which a wave can propagate, and a boundary that suitably confines the propagation of the wave. The boundary may be provided by any suitable material with sufficiently different optical properties e.g. by an air interface and/or cladding interface. The core and the cladding (or at least the core and the boundary) therefore co-operate to provide the waveguide. By suitable configuration of the core and the cladding (or the core and the boundary) the waveguide may be configured to be single-mode.

The method may comprise forming cladding within the sapphire optical fibre to thereby indirectly form the single-mode waveguide (e.g. by not directly modifying the optical core). The method may therefore comprise changing the properties (e.g. of bulk sapphire) within the optical fibre to in effect form cladding thereby, which cladding is configured to co-operate with an unmodified portion (e.g. an optical core) of the sapphire optical fibre to thereby provide the waveguide.

Single-mode optical fibres are known, though a single-mode sapphire optical fibre had not previously been realized prior to the methods disclosed in GB1712640.0, at least in part because of the difficulties inherent in working with sapphire for laser modification, and working with sapphire fibre. Thus, GB1712640.0 disclosed the first laser-fabricated single-mode sapphire optical waveguide in a sapphire optical fibre. Single-mode optical fibres are optical fibers designed to carry only a single mode of light. Single-mode optical fibres may satisfy a single mode criterion, for example having a normalised frequency less than a predetermined threshold. For example, for a step-index fibre the normalised frequency may be less than 2.4. For other types of fibre, for example photonic crystal fibres, depressed cladding fibres, micro-void fibres, photonic bandgap fibres, etc., the threshold may be different.

The method may comprise configuring the waveguide (e.g. by laser-modification) to be single-mode. The method may comprise configuring the waveguide so as to prevent propagation therein of all but a single mode of light. The method may comprise modifying the fibre to ensure predetermined modes experience increased loss during propagation. The method may comprise fabricating (e.g. laser-writing) a step-index waveguide within the optical fibre. The method may comprise fabricating (e.g. laser-fabricating) a periodic structure waveguide (e.g. with a periodic variation in refractive index over the cross-section), a photonic-crystal fibre, a micro-void fibre, photonic bandgap fibre, or the like within the optical fibre. The single-mode waveguide may restrict the transmission of energy to substantially one direction. The method may comprise modifying only the interior of the fibre. The method may comprise providing the laser-fabricated waveguide fully within a sapphire optical fibre. The method may comprise providing the laser-fabricated waveguide embedded within a sapphire optical fibre.

The fibre may be a hollow core fibre e.g. in which the core is a void (e.g. air or another fluid/liquid/gas). The fibre may be a photonic crystal fibre with a hollow core. The fibre may be an anti-resonant fibre or a negative curvature fibre with a hollow core. The hollow core may be filled with a suitable material e.g. gas (e.g. helium, neon, carbon dioxide, rubidium, nitrogen, and so on) and a gas laser may thus be provided. The hollow core fibre may be a non-sapphire fibre.

The method may comprise configuring the waveguide to increase losses for predetermined propagating modes, and thereby configure the waveguide to be single-mode. The method may comprise configuring the waveguide to cause higher order modes to experience increased losses during propagation. The method may comprise producing the waveguide within the fibre to cause a loss of greater than about 1 dB (decibel) per metre, about 3 dB per metre, about 10 dB per metre, about 15 dB per meter, or about 20 dB per metre for predetermined modes.

The method may comprise modifying the optical fibre so that all but a single mode experience losses in the waveguide e.g. losses of greater than about 1 dB per metre, about 3 dB per metre, or about 10 dB per metre. The method may comprise producing a sapphire optical fibre which supports a reduced number of modes in the waveguide therein.

Thus, the sapphire fibre may comprise laser-modified regions configured to cause a plurality of modes to exhibit losses during propagation within the waveguide, and may cause all but a single mode to exhibit losses during propagation within the waveguide. The sapphire optical fibre may be configured to support substantially a single propagation mode in the waveguide.

The sapphire optical fibre may comprise bulk material having a first refractive index and an optical core having a second refractive index different to the first refractive index. The bulk sapphire may have only the first refractive index, so that the optically functional part of the fibre consists of only the optical core for propagation of a single mode, and a homogeneous surrounding sapphire material.

The sapphire optical fibre may comprise an optical core (e.g. of unmodified sapphire) having a first refractive index and a surrounding modified material (e.g. a cladding and/or depressed cladding) having a second refractive index. A boundary may therefore exist between the regions with different refractive indices, which boundary may be arranged to provide the waveguide. The waveguide may therefore be formed by the co-operation of the material having the first refractive index with the material having the second refractive index.

The waveguide may comprise a region of modified refractive index configured to guide light therein. The waveguide may comprise modified regions having modified refractive indices which may be substantially solid. The modified regions may comprise modified material comprising micro-voids therein. The modified regions may be periodic, and may provide a micro-structure and/or a photonic crystal. The sapphire fibre may be a micro-structured fibre and/or a photonic crystal fibre comprising an array of modified regions thereby forming the waveguide. The modified regions may serve to define an optical core as a light-guiding region of the sapphire fibre. The sapphire fibre may thus be configured so that the waveguide comprises an unmodified region and/or a modified region. The waveguide may be formed by co-operation of the optical core (e.g. an unmodified core) and the laser-modified regions (e.g. laser-fabricated micro-structures, laser-fabricated periodic structures, laser-fabricated photonic crystals, laser-fabricated depressed cladding, and so on). The laser modified regions may therefore surround the optical core and hence act as cladding for the single-mode waveguide (although fully within the optical fibre). The laser modified regions may comprise voids or holes which may be filled with air or another fluid (i.e. another gas or liquid).

The single-mode sapphire optical waveguide may have a normalized frequency V less than a predetermined threshold applicable to the type of fibre. For example, the single-mode sapphire optical waveguide may have a normalized frequency V less than 2.4 for a step-index fibre, and may have a normalized frequency less than 2.405. The normalized frequency V may be defined as:

$$V = \frac{2 π a}{λ} \sqrt{{n}_{1}^{2} - {n}_{2}^{2}}$$

where a is the waveguide radius, λ is the wavelength of operation, n₁ is the core refractive index and n₂ is the cladding refractive index. Sapphire has a refractive index of around 1.75, so to be single-mode at 1550 nm, with an index modification of 0.005 between the waveguide and cladding, the waveguide radius should be less than 4.47 μm (diameter less than 8.94 μm).

The single-mode sapphire optical fibre may comprise the optical core and cladding surrounding the core. The single mode propagating in the waveguide may therefore be substantially confined to the optical core. Light may be restricted to (and therefore guided along) the waveguide (e.g. along the optical core) as a result of the change in refractive indices between the core and the cladding, or at least as a change in the optical properties between the core and the cladding. This change in refractive indices between adjacent materials may provide the waveguide by the core-cladding interface. The waveguide may therefore be provided by co-operation of the core and cladding, or by the boundary therebetween. The single-mode sapphire optical waveguide may comprise a region in which light of a single mode is constrained to propagate; the region being formed of a sapphire-based material. The waveguide may be a core of the sapphire optical fibre. The single-mode sapphire optical waveguide may comprise a core and a core-cladding interface. The light-guiding portion of the waveguide may therefore be considered to be coincident with the core. The core may therefore provide the gain medium.

It should be noted that the term “cladding” used herein includes modified material within a fibre, which modified material behaves analogously to the cladding of a typical optical fibre by providing a boundary. The cladding may be entirely within the optical fibre. Indeed, the cladding may be surrounded by unmodified fibre material e.g. bulk sapphire.

The method may comprise generating light by stimulated emission. The method may comprise: exciting the gain medium (e.g. the optical core) using a pump light. The method may comprise stimulating the excited gain medium to emit light using a signal or input light.

The gain medium within the waveguide may be doped sapphire. The doping of the sapphire may enable it to act as a gain medium. The doping element may be any suitable doping element that enables the waveguide to act as a gain medium. In particular, the doping element may be titanium, or may be chromium, or may be any suitable combination of elements. The optical fibre may be a titanium doped sapphire fibre e.g. a Ti:sapphire fibre.

The single-mode sapphire optical waveguide may be configured to counteract propagation losses. The method may comprise providing gain using the single-mode sapphire optical waveguide to thereby overcome propagation losses in the waveguide. Thus, the method may enable the use of longer sapphire optical fibres. Commercially available sapphire fibres are typically less than a length of around 4 meters, and by providing a sapphire optical fibre comprising a single-mode sapphire optical waveguide to counteract propagation losses, such a limit to the length of the sapphire fibres will not be encountered. That is, the use of longer fibres may be possible by the methods recited here. Thus, the invention may comprise providing a single mode sapphire optical fibre longer than 2.5 centimeters (cm), longer than 5 cm, longer than 10 cm, longer than 15 cm, longer than 20 cm, longer than 30 cm, longer than 50 cm, longer than 1 meter (e.g. 1.00 m), longer than 2 meters (e.g. 2.00 m), or longer than 4 meters (e.g. 4.00 m). The length of the single mode sapphire optical fibre may be suitable for real-world applications.

The method may comprise using the single-mode sapphire optical waveguide as a gain medium to amplify signal light.

The method may therefore comprise amplifying signal light, and hence the single-mode sapphire optical waveguide may be used as an optical amplifier. The optical amplifier may be a device that amplifies the signal directly e.g. without the need to first convert it to an electrical signal. The optical amplifier may be thought of as a laser without an optical cavity, or one in which feedback from the cavity is suppressed. The method may comprise using the sapphire optical fibre in an optical amplifier. The method may comprise providing the optical amplifier. The method may comprise providing the optical amplifier as an optical repeater e.g. for use in communications systems such as telecommunications. Indeed, seen from another perspective an aspect of the invention provides a method of amplifying an optical signal comprising using a single-mode sapphire optical waveguide as a gain medium. This aspect may comprise any of the features as described herein with reference to any other aspect of the invention.

The method (of any aspect of the invention) may comprise stimulating the gain medium e.g. to thereby generate an amplification of the signal light. The method may comprise pumping the gain medium to excite it and thereby enable amplification of signal light.

The method may comprise using the single-mode sapphire optical waveguide as a gain medium to generate laser light.

The method may therefore comprise providing a single-mode sapphire optical fibre laser. The method may comprise stimulating emission of the light from the gain medium provided by the single-mode sapphire optical waveguide. The method may comprise pumping the gain medium e.g. using pump light. The method may comprise providing an optical cavity (e.g. a resonator cavity of a laser system), and may comprise proving the single-mode sapphire optical fibre as at least part of the optical cavity.

Indeed, seen from another perspective an aspect of the invention provides a method of generating laser light using a single-mode sapphire optical waveguide as a gain medium. The method may therefore comprise using a single-mode sapphire optical fibre as the gain medium, the optical fibre comprising the single-mode sapphire waveguide. This aspect may comprise any of the features of the invention described herein with reference to any other aspect of the invention. Seen from another perspective an aspect of the invention provides a single-mode sapphire optical fibre laser. This aspect may comprise any of the features of the invention described herein with reference to any other aspect of the invention.

The method (of any aspect of the invention) may comprise pumping the single-mode sapphire optical waveguide using pump light above a predetermined threshold power level. The method may comprise stimulating emission of light from the pumped single-mode waveguide. The method may comprise providing a source of pump light e.g. a pump laser, diode laser, semiconductor laser or the like, and configuring the source of pump light to excite the single-mode sapphire optical fibre for subsequent stimulated emission therefrom. The method may comprise a population inversion to enable stimulated emission. The method may comprise using any suitable pump means to pump the gain medium, that is, any suitable means to excite the gain medium such as via electric currents, chemical reactions, nuclear fission or high energy electron beams.

The method may comprise pumping the gain medium with a diode laser. Diode laser are typically difficult to efficiently use with e.g. titanium doped sapphire, but by provision of the waveguide, more efficient coupling of the pump into the gain medium is possible. Thus, a smaller, cheaper, lighter system may be achieved.

The method may comprise mode-locking the single-mode sapphire optical fibre laser. The method may comprise using the single-mode sapphire optical waveguide to generate laser pulses.

The method may comprise providing an optical cavity e.g. using a feedback device. The method may comprise fabricating the feedback device. The feedback device may be a reflector. The feedback device may be a grating, a Bragg grating, a diffraction grating, a mirror, a dielectric mirror, a sapphire-air interface of the optical fibre and/or the optical waveguide, and so on. The reflector may be tunable e.g. may be tunable grating e.g. that is rotatable and thereby tunable. The method may therefore comprise tuning the output of the laser light emitted by the gain medium, for example, varying and/or selecting the wavelength of the light output from the laser. Thus, a tunable laser can be realized and the method may comprise providing a tunable laser. The ability to vary and select the wavelength emitted by the gain medium allows the laser to be used e.g. to investigate an optical spectrum. For example, absorption lines or peak wavelengths within a spectrum can be investigated. The tunable system also allows the wavelength peak of a fabricated fibre Bragg grating (FBG) to be determined.

The grating may be outside the optical fibre e.g. adjacent thereto, and/or in optical communication therewith. That is, the reflector and/or grating may be a component additional to the optical fibre.

The method may comprise forming an optical cavity (e.g. a laser cavity) comprising the single-mode sapphire optical waveguide. The method may comprise providing a reflector and either end of the waveguide to thereby form the cavity. The method may comprise providing the reflector(s) within the single-mode sapphire optical waveguide and/or within the sapphire optical fibre. The method may comprise fabricating the reflector(s) within the single-mode sapphire optical waveguide. The method may therefore comprise providing a single-mode sapphire optical fibre optical cavity for a laser system.

The method may comprise fabricating a Bragg grating within the single-mode sapphire optical waveguide.

The method may comprise using the Bragg grating to reflect light within the waveguide, and may therefore comprise using the fabricated Bragg grating as a reflector e.g. as part of an optical cavity, or as part of a sensor system. The method may comprise detecting the reflected light from the Bragg grating, and may comprise using the single-mode sapphire optical fibre as a part of a sensor system. For example, the method may comprise determining a physical parameter (e.g. temperature, pressure, strain, magnetic field, electric field, vibration and/or shock) on the basis of the reflected light from the Bragg grating. Since sapphire is an extremely durable material, the sapphire optical fibre may be used in extreme environments e.g. with an engine or the like. The method may comprise disposing at least a portion of the sapphire optical fibre in an extreme environment e.g. in an engine in order to detect a physical parameter within the environment (e.g. temperature, pressure, strain, magnetic field, electric field, vibration and/or shock). For example, the method may comprise disposing at least a portion of the sapphire optical fibre in an aerospace engine. The method may comprise utilizing the sensor system comprising the sapphire optical fibre in environments that experience high levels of radiation. For example, the method may comprise utilizing the sensor system comprising the sapphire optical fibre in nuclear reactors, and in particular in nuclear fission power reactors or nuclear fusion power reactors, and/or in satellites and other equipment suitable for use in space. Sapphire is also transparent in the mid-IR (e.g. wavelengths >2 μm). Thus, the sensor system comprising the sapphire optical fibre may be usefully employed for spectroscopy and gas species detection.

The method may comprise configuring the Bragg grating (or each Bragg grating where a plurality of gratings is provided) to be tunable e.g. via temperature or strain. For example, the structure of the grating may undergo changes when exposed to different conditions—for example the spacing may depend upon the temperature of the optical fibre. The method may therefore comprise reconfiguring and/or deforming a Bragg grating within the waveguide, and detecting a change of reflected light as a result of that reconfiguration or deformation, to thereby detect a change in a parameter to be measured e.g. temperature and/or strain.

The method may comprise providing a plurality of Bragg gratings within the optical fibre e.g. to provide an optical cavity or for performing multiple measurements. The method may comprise providing a plurality of Bragg gratings, each within a respective optical core (i.e. each within a respective waveguide), and/or may comprise providing a plurality of Bragg gratings within the same optical core e.g. in series or overlapping with each other. The method may comprise using the optical fibre to perform multiple simultaneous measurements of physical parameters e.g. by detecting multiple reflected signals from a plurality of Bragg gratings.

The Bragg grating(s) may have a narrow bandwidth e.g. less than 5 nm (nanometers), less than 2 nm, less than 1 nm, less than 0.5 nm, or less than 0.1 nm.

The method may comprise providing a plurality of waveguides within the optical fibre, and may comprise providing a plurality of single-mode waveguides within the optical fibre e.g. in parallel, or adjacent. The method may comprise providing overlapping waveguides within the optical fibre. The method may therefore comprise fabricating a plurality of waveguides within the optical fibre.

The method may comprise providing opposed Bragg gratings within the single-mode sapphire optical waveguide to thereby form an optical cavity.

The method may comprise fabricating the opposed Bragg gratings within the single-mode sapphire optical waveguide by laser modification e.g. using an adaptive optical element to correct aberration of the modifying laser focus caused by the fibre. The method may therefore comprise providing a sapphire optical fibre comprising a laser cavity e.g. a laser cavity comprising a single-mode sapphire optical waveguide.

The method may comprise using the single-mode sapphire optical waveguide as part of a sensor system.

Since sapphire is very durable and able to withstand high temperatures e.g. up to 1000° C., up to 1500° C., up to 1700° C., up to 1900° C., and up to 2000° C., the optical fibre and single-mode waveguide may be used in extreme environments, for example within an engine or any other suitable use. The method may therefore comprise using the single-mode sapphire optical waveguide in extreme conditions e.g. up to 1000° C., up to 1500° C., up to 1700° C., up to 1900° C., and up to 2000° C. The method may comprise using the sensor system to measure temperatures e.g. up to 1000° C., up to 1500° C., up to 1700° C., up to 1900° C., and up to 2000° C. Bragg gratings may also be stable up to such high temperatures, and the method may therefore comprise using a fibre Bragg grating in a temperature of up to 1000° C., up to 1500° C., up to 1700° C., up to 1900° C., and up to 2000° C.

The single-mode sapphire optical waveguide may be a depressed cladding waveguide.

The depressed cladding waveguide may be a laser-modified sapphire optical fibre as described herein with reference to any aspect of the invention. The depressed cladding may therefore be sapphire. The depressed cladding may be laser-modified to reduce its diffractive index e.g. compared to unmodified material within the optical fibre. The depressed cladding may therefore have a lower refractive index than an unmodified portion and may co-operate with the unmodified portion to thereby form the waveguide. In a depressed cladding waveguide the index of the sapphire may be lowered (e.g. homogenously) around a core. The lowered index may not extend all the way to the edge of the sapphire fibre, and therefore the cladding may be surrounded by unmodified optical fibre.

The depressed cladding waveguide may be a multi-layer depressed cladding waveguide, comprising a plurality of layers of modified fibre material providing multiple layers of cladding.

The single-mode sapphire optical waveguide may be a photonic crystal waveguide (comprising a cladding comprising a periodic array of regions within the cladding having a modified index).

The cladding may comprise a periodic array of ‘holes’, e.g. regions where the material has been removed. This could be air (having a refractive index of ˜1) or another fluid (i.e. a liquid or gas).

The method may comprise fabricating the single-mode sapphire optical waveguide using laser modification and adaptive optics aberration compensation.

The method may comprise using femtosecond laser direct writing, for example using a method as disclosed in GB1712640.0, the contents of which are hereby incorporated herein in their entirety. The inventor has discovered that the methods and features disclosed therein may be combined with features to the present invention.

The method may comprise using non-immersion lenses e.g. to focus with the fibre. The method may comprise counteracting an effect of aberration on laser focus caused by the sapphire e.g. a sapphire-air interface, a sapphire-cladding interface, a sapphire-modified-sapphire interface, and so on.

The method may comprise fabricating the single-mode sapphire optical waveguide using an immersion-oil technique and an immersion objective lens. The method may comprise fabricating the single-mode sapphire optical waveguide by embedding the sapphire fibre within a substrate of similar refractive index (e.g. a block of sapphire with a hole along its length to incorporate the sapphire). The step of fabricating may comprise counteracting the aberrating effect of the fibre on a focus of a modifying laser.

The method may comprise providing the single-mode sapphire optical waveguide within a sapphire optical fibre, and using the sapphire optical fibre as a multimode waveguide while simultaneously using the single-mode sapphire optical waveguide as a single-mode waveguide.

The method may therefore comprise providing the single-mode waveguide within a multimode waveguide. The method may comprise propagating multiple modes of light within the sapphire optical fibre as a pump for the single-mode sapphire optical waveguide. Sapphire fibre is naturally multimode and therefore multiple modes of light can propagate along the fibre e.g. by virtue of a sapphire-air boundary. The optical fibre can therefore be considered to be a combination of waveguides e.g. a first single-mode sapphire optical waveguide, and a second multimode waveguide provided by the rest of the fibre. Thus, the propagation modes in the multimode waveguide of the fibre may excite the gain medium of the single-mode waveguide for subsequent stimulated emission e.g. by the single-mode propagating within the waveguide. The method may comprise propagating pump light within the optical fibre and thereby overlapping the pump light with the single-mode waveguide to excite ions within the single-mode waveguide. Thus, the method may comprise using multiple modes of light propagating within the optical fibre to pump the single-mode waveguide.

An input signal can then stimulate emission from the pumped single-mode waveguide. The method may therefore comprise using a single source of light for the pump light and the input signal light. The input signal may therefore be a fundamental mode of a source laser, and may propagate within the single-mode sapphire optical waveguide. Higher-order modes from the source laser may propagate within the rest of the optical fibre, and may therefore pump the single-mode waveguide.

The method may comprise fabricating cladding within a sapphire optical fibre to form laser-modified cladding about an optical core, the optical core and the cladding thereby co-operating to provide the single-mode sapphire optical waveguide.

The method may comprise fabricating a depressed cladding waveguide by lowering the refractive index of the material surrounding the optical core e.g. to form a material with substantially uniform refractive index. The method may comprise laser-fabricating periodic structures about the core to thereby form the cladding e.g. to form a material with periodically varying refractive index. The periodic structures may be micro-structures (e.g. structures on a microscopic length scale), micro-voids, photonic crystal structures, photonic bandgap structures, and so on. The method may comprise fabricating structures that are not periodic.

The method may comprise only modifying material within the sapphire optical fibre, and for example may comprise not changing the overall shape of the cross-section of the fibre. That is, the surface of the optical fibre may not be modified. The fibre may have a cylindrical shape, or more commonly for sapphire fibres it may have a substantially hexagonal cross-section. The cross-section of the optical fibre may be hexagonal, or rounded hexagonal. Since the overall shape of the optical fibre's cross-section is substantially the same as prior to modification, the fibre may substantially maintain the same mechanical properties. For example, it may not be necessary to removed material from the fibre to provide the invention, and hence may not be necessary to weaken the fibre and make it more mechanically vulnerable. Thus, the waveguide (or the plurality of waveguides) may consist of sapphire material, both modified and unmodified.

The cladding may be a first cladding, and the method may comprise fabricating a second cladding about the first cladding.

The method may comprise fabricating nested claddings within the optical fibre. The method may comprise a double-clad fibre, with the multi-layer cladding fabricated within the fibre. The second cladding may have a different refractive index (e.g. lower) than that of the first cladding. The second cladding may be any type of cladding as discussed herein with reference to any aspect of the invention. The second cladding may have different optical properties to the first cladding e.g. a different refractive index (e.g. lower) to the first cladding. It may have a different micro-structure, a different period, and so on. The second cladding may be configured to act as cladding for a second optical core provided by the first cladding. That is, the first cladding may surround an optical core of the single-mode waveguide, and the second cladding may surround the first cladding. The first cladding may therefore be used as a (second) optical core for a multimode waveguide bounded by the second cladding, and the (first) optical core may be used as the single-mode waveguide bounded by the first cladding. The first and second cladding may be formed of sapphire-based material.

The optical fibre may be configured to comprise a plurality of waveguides. The optical fibre may be configured to comprise a plurality of overlapping waveguides.

The optical fibre may comprise a plurality of nested waveguides. The cross-sections of the waveguides may overlap e.g. one waveguide may be within the other. The plurality of waveguides may overlap in a radial sense so that an inner waveguide and an outer waveguide is formed. A central longitudinal axis of an outer waveguide may be located within the region of a respectively inner waveguide e.g. the waveguides may be concentric (though the waveguide may not necessarily have a circular symmetry). The cladding of an inner waveguide may serve as the optical core of an outer waveguide. The optical fibre may therefore be configured to provide a multimode waveguide surrounding the single-mode waveguide, and the method may comprise propagating multiple modes of light in the multimode waveguide to thereby pump the single-mode waveguide. The method may comprise using the cladding as a pump waveguide. The method may therefore comprise providing a cladding-pumped single-mode sapphire optical waveguide i.e. a cladding-pumped gain medium. The second (or outer) cladding may be surrounded by non-modified sapphire optical fibre. That is, the single-mode waveguide and the multimode waveguide may be fully within the optical fibre, both fabricated therein.

The method may comprise doping a sapphire optical fibre to form a doped region therein and fabricating the optical core of the single-mode sapphire optical waveguide within the doped region.

The doped region may comprise the whole of the cross-section of the optical fibre. Alternatively, the doped region may comprise only a portion of the sapphire optical fibre e.g. a portion of the cross-section of the fibre. For example, only an inner region of the fibre intended to provide the optical core of the single-mode waveguide may be doped. The doped portion may therefore be surrounded by undoped sapphire material. The method may comprise doping only an inner portion of the optical fibre, so that a cross-section of the fibre thereby comprises an inner doped portion (e.g. a central portion) surrounded by a non-doped portion.

Thus, the sapphire optical fibre (e.g. a cross-section thereof) may comprise both the doped region and a region that is not doped. Only a portion of a cross-section of the sapphire optical fibre may be doped, and the single-mode sapphire optical waveguide may be formed within the doped portion. The doped portion may be off-centre within the optical fibre, for providing an off-centre optical core as discussed herein.

By doping only a portion of the fibre (e.g. only a portion of the cross-section of the fibre) the risk is reduced of energy being absorbed by doped material from higher-order propagation modes propagating in the optical fibre but outside the single-mode waveguide. If the cladding of the single-mode waveguide (e.g. a second optical core of a cladding-pumped single-mode waveguide) is doped, it may absorb pump power without contributing to optical gain, and therefore overlap between a core of a pump waveguide and the doped portion should preferably be minimized. In a cladding-pumped single-mode waveguide, the optical core of the single-mode waveguide may be provided within the core of the pump waveguide. By providing the doping within the optical core of the single-mode waveguide, the core of the pump waveguide may comprise doped material at least where this overlap between the core of the single-mode waveguide and the core of the pumped waveguide occurs. Any additional overlap between the doped region and the core of the pump waveguide should preferably be minimized.

It would therefore be preferable to dope only as much of the fibre as needed to provide the core of the single-mode waveguide. However, such a precise control over the extent of the doped portion is difficult to achieve, and therefore it may be necessary to dope a larger region than is required for the core of the single-mode waveguide.

The method may comprise fabricating the single-mode sapphire optical waveguide off-centre within a sapphire optical fibre.

The method may comprise fabricating the single-mode sapphire optical waveguide near a periphery of the doped portion e.g. off-centre relative to and within the doped portion of the fibre e.g. at an edge of the doped portion (the doped portion may itself be off-centre within the fibre). The single-mode waveguide may be provided at a periphery of the doped region, which in turn allows the overlap of fabricated cladding surrounding the optical core of the single-mode waveguide with the doped portion to be reduced (and ideally minimized). Thus, when the cladding of the single-mode waveguide is used as a pump waveguide, this arrangement may reduce the pump energy lost to doped material in the pump waveguide/first cladding. That is, by providing the optical core of the single-mode waveguide at the periphery of the doped portion, the risk of pump power being lost in doped cladding is reduced.

In addition to the above advantages, the method may comprise providing the gain medium/optical core of the single-mode waveguide off-centre in order to increase an overlap of pump modes with the single-mode waveguide gain medium. If the optical core of the single-mode waveguide (e.g. that which guides the laser mode and is doped with an active ion) is precisely in the middle of a multimode pump waveguide, then there may be modes of the multimode guide that do not overlap significantly with the gain medium of the optical core of the single-mode waveguide and so the light coupled into those modes of the multimode guide may not be absorbed by the gain medium of the optical core of the single-mode waveguide and instead may exit the fibre unused. By providing the optical core of the single-mode waveguide off-centre, the energy absorbed by the gain medium from the pump modes may be increased. The optical core of the single-mode waveguide may therefore be off-centre within the optical fibre, as well as off-centre within any pump waveguides that may also be provided.

Another approach for increasing the amount of energy absorbed from the pump modes by the gain medium is to reduce the cross-sectional symmetry of the multimode waveguide, for example by making it elliptical or D-shaped in cross-section. The method may therefore comprise providing a pump waveguide with an asymmetric feature. The method may comprise providing such an asymmetric feature to increase the energy absorbed by gain medium from the pump modes.

The method may comprise fabricating the single-mode sapphire optical waveguide comprising an asymmetric feature.

For example, the method may comprise fabricating the single-mode sapphire waveguide to have an elliptical cross-section (e.g. in a plane perpendicular to the length of the optical fibre). The resulting waveguide may be polarization maintaining so that the polarization state of e.g. the single mode is maintained when the optical fibre is bent. The method may therefore comprise providing a polarization maintaining single-mode sapphire optical waveguide.

The method may also comprise fabricating the cladding of the single-mode waveguide to comprise an asymmetric feature, for example having an elliptical cross-section.

The method may comprise coupling a pump laser to the single-mode sapphire optical waveguide.

The method may comprise providing a pump laser for pumping the gain medium i.e. for pumping the single-mode sapphire optical waveguide. The method may comprise exciting the gain medium using the pump laser. The method may comprise stimulating emission from the gain medium using the pump laser. The pump laser may be any suitable type of laser, for example an argon ion laser. The pump laser may be a diode laser. The method may comprise providing an optical amplifier and/or a laser system. The method may comprise providing any and all components for an optical amplifier and/or laser system.

Combinations of the features described above may have particular advantages. For example, the combination of a cladding-pumped single-mode sapphire optical waveguide with asymmetric features of the pump waveguide may improve coupling of pump modes into the gain medium. Having the optical core of the single-mode waveguide off-centre within the pump waveguide may further improve the coupling of modes into the gain medium and improve energy transfer. The selective doping to reduce the overlap of the pump-waveguide with doped material may further improve energy transfer by reducing loss into the pump waveguide.

According to a second aspect of the invention there is provided a sapphire optical device comprising an optical gain medium comprising a single-mode sapphire optical waveguide.

The sapphire optical device may comprise any of the features discussed herein with reference to the first aspect of the invention, and/or with reference to any other aspect of the invention.

The sapphire optical device may be a sapphire optical fibre. The sapphire optical device may be bulk sapphire (e.g. a block or rod) with the single-mode sapphire optical waveguide therein. The diameter of the optical core of the single-mode waveguide may be less than 20 micrometers (μm), less than 15 μm, less than 10 μm, or may be 10 μm or less.

The diameter of the sapphire optical fibre may be less than 1000 μm, less than 425 μm, less than 250 μm, less than 125 μm, less than 100 μm, less than 75 μm or less, or may be 50 μm or less. The diameter of the cladding surrounding the core may be the same as the diameter of the sapphire optical fibre (e.g. if a single waveguide is provided within the sapphire optical fibre). The diameter of the cladding surrounding the core may be different to the diameter of the fibre (e.g. where additional material is provided surrounding the cladding, or where a plurality of waveguides are provided within the sapphire optical fibre, or where a cladding pumped optical waveguide is provided as discussed further below), and the diameter of the cladding may be less than 425 μm, less than 250 μm, less than 125 μm, less than 100 μm, less than 75 μm or less, or may be 50 μm or less. The diameter of the cladding surrounding the core may be more than 2.5 times the diameter of the core or more, or may be 5 times the diameter of the core or more, or 10 times the diameter of the core or more, or may be 20 times the diameter of the core or more. A cladding diameter of 5 times the diameter of the core or more is advantageous for achieving low loss.

The length of the single-mode sapphire optical waveguide may be the same length as the fibre. For example, the single-mode sapphire optical waveguide may continue along the entire length of the sapphire optical fibre. The length of the sapphire optical fibre may be e.g. 5 cm or more, 10 cm or more, 50 cm or more, 100 cm or more, or 200 cm or more.

The sapphire optical device may comprise a Bragg grating.

The Bragg grating may be within the single-mode sapphire optical waveguide. It may be suitable for use as part of a sensor system, and/or it may be provided to reflect a predetermined wavelength to thereby provide feedback to form a laser system. The device may comprise a plurality of Bragg gratings, for example in series and/or overlapping.

The sapphire optical device may comprise opposed Bragg gratings providing an optical cavity for a laser system. The opposed Bragg gratings may be at substantially the same wavelength.

The device may comprise two opposed Bragg gratings, each within the single-mode sapphire optical waveguide. The Bragg gratings may be laser-fabricated within the waveguide. The two opposed Bragg gratings may be at substantially the same wavelength.

The single-mode sapphire optical waveguide may be a depressed cladding waveguide.

The waveguide may be a periodic structure waveguide, and/or a micro-structure waveguide. The waveguide may be a photonic crystal waveguide, a micro-void waveguide, a photonic bandgap waveguide, and so on.

The sapphire optical device may be a laser-modified sapphire optical fibre.

The sapphire optical fibre may be a step-index fibre, a photonic crystal fibre, a depressed cladding fibre, a micro-void fibre, a photonic bandgap fibre, and so on. The optical device may be formed by etching, index matching, and so on.

The sapphire optical device may be a multimode sapphire optical fibre, and the single-mode sapphire optical waveguide may be disposed within the multimode fibre.

The sapphire optical device may therefore comprise overlapping waveguides. The sapphire optical device may comprise nested waveguides e.g. an inner waveguide (e.g. the single-mode waveguide) disposed within an outer waveguide (e.g. a pump waveguide having an optical core which is the cladding of the inner waveguide).

The optical device may be configured so that propagating modes in the multimode fibre act as pump light for the single-mode waveguide. The optical device may therefore comprise a plurality of waveguides, at least one of which is a single-mode waveguide and another of which is a multimode waveguide.

The sapphire optical device may comprise a doped region, and wherein the optical core of the single-mode sapphire optical waveguide is within the doped region.

The single-mode sapphire optical waveguide (e.g. the optical core thereof) may be off-centre relative to and within the doped region. The optical core of the single-mode waveguide may be at the edge of the doped region. The doped-region may be off-centre within the optical device. The single-mode waveguide may be off-centre relative to and within the optical device.

The single-mode sapphire optical waveguide may be off-centre relative to and within a multimode waveguide e.g. the multimode waveguide being provided by the rest of the optical fibre other than the single-mode waveguide, or provided by a cladding of the single-mode waveguide. The optical device may therefore comprise a pump waveguide for propagating multimode light therein to pump the single-mode waveguide. The optical device may comprise a cladding-pumped single-mode sapphire optical waveguide. The pump waveguide may with within (e.g. surrounded by) unmodified optical fibre material.

The single-mode sapphire optical waveguide may comprise laser-fabricated cladding surrounding an optical core.

The laser-fabricated cladding may therefore comprise differing optical properties to the optical core, and may co-operate therewith to provide the single-mode sapphire optical waveguide. The cladding may be substantially homogenous with a substantially uniform refractive index. Alternatively, the cladding may be a periodic structure as described herein e.g. comprising periodically varying micro-structures and optical properties over its cross-section.

The laser-fabricated cladding may be a first cladding, and the optical device may comprise a second laser-fabricated cladding surrounding the first cladding.

The second cladding may have a different (e.g. lower) refractive index to the first cladding. The first cladding may act as a second optical core that co-operates with the second cladding to provide a multimode waveguide for pumping the gain medium of the single-mode waveguide.

According to a third aspect of the invention there is provided a laser system for generating laser light comprising the optical device as described herein with reference to the second aspect of the invention. The optical device may provide the gain medium of the laser system.

The laser may be a mode-locked laser as described herein. The laser system may comprise a feedback device as described herein. The laser system may comprise rotatable gratings which are thereby tunable. The laser system may comprise a diode pump laser, or any suitable pump laser. The laser system may be configured to perform the method of the invention as described herein with reference to the first aspect, or any other aspect.

According to a fourth aspect of the invention there is provided an optical amplifier comprising the optical device as described herein with reference to the second aspect of the invention. The optical device may provide the gain medium of the optical amplifier.

The optical device may be an optical amplifier of a sensor system. Thus, rather than having a separate amplifier, the waveguide itself may be active and the loss of the waveguide may be compensated by the optical gain (this may also apply to use as a laser). The waveguide may therefore be considered to be a distributed amplifier. Therefore, according to another aspect of the invention there is provided a sensor system comprising the optical amplifier as recited herein with reference to any aspect of the invention. The sensor system may be configured to perform the method as described herein with reference to any aspect of the invention, and may comprise any of the features described herein with reference to any aspect of the invention.

By providing a fibre (e.g. a fibre laser or optical amplifier) that has collinear waveguides for multimode pump and single-mode propagation, the invention may reduce gain limitations, and also may improve (or maximise) the worthwhile absorption of pump light, which in turn may enable the use of cheap, low brightness pumps such as diode lasers. The invention may therefore reduce the cost of e.g. a Ti:sapphire laser. The invention may also provide built-in engineering advantages such as pump redundancy and also rapid, relatively easy pump modulation for control of a laser operation (e.g. by feedback stabilisation of the power via the diode current). The invention may provide an all fiberized Ti:sapphire laser e.g. that has 10 W output power from a robust package with built-in pump redundancy and e.g. fibre Bragg grating control of the spectral output.

According to a fifth aspect of the invention there is provided a sensor system comprising the optical device as described herein with reference to the second aspect of the invention. The sensor system may comprise the optical amplifier as recited herein with reference to the fourth aspect of the invention. The sensor system may comprise any of the features recited herein with reference any aspect of the invention.

According to a further aspect of the invention there is provided an optical gain element, the optical gain element comprising: a single-mode sapphire optical waveguide with optical gain. This has the advantage that sapphire can be used as a gain medium, whilst maintaining a single transverse mode. This aspect may comprise any of the feature of the invention as recited herein with reference to any other aspect of the invention.

The sapphire optical waveguide may be a sapphire optical fibre. The sapphire optical waveguide may be within a sapphire optical fibre. These have the advantage that the fibre can provide a longer interaction length with the gain medium.

The single-mode waveguide may have an active gain medium. The single-mode sapphire waveguide may be doped. The single-mode sapphire waveguide may be doped with titanium. The single-mode sapphire waveguide may be doped with a rare earth element. The single-mode sapphire waveguide may be co-doped with two or more elements. The single-mode sapphire waveguide may be doped with any one or more of: ytterbium, erbium, neodymium, erbium, thulium, praseodymium, palladium, holmium, chromium, cobalt, iron, magnesium, manganese, nickel or carbon. The optical gain element may provide gain at a different wavelength to that of a pump laser. These have the advantage of allowing optical gain.

There may be a pump laser coupled to the sapphire optical waveguide. This has the advantage of allowing the gain medium to be excited.

The sapphire waveguide may be single-mode for signal light and multi-mode for pump light. This has the advantage of allowing efficient coupling of pump lasers with divergent beams. High power pump lasers are typically divergent, so it is difficult to couple much light into a single mode fibre. However, this arrangement allows the pump light to excite the ions in the single-mode waveguide. Double-clad fibres are known in fibre amplifier design, but normally comprise an outer jacket around the fibre, to form an additional cladding. The optical fibre of the present invention may comprise an outer cladding around the sapphire optical fibre, or the pump light may be guided by the sapphire-air interface. Alternatively, a femtosecond laser could be used to write a multimode waveguide around the single-mode waveguide, so that the optical fibre itself provides a double-clad waveguide arrangement.

The single-mode sapphire fibre may comprise a single-mode waveguide comprising a core of gain medium and a cladding surrounding the core. The single-mode waveguide may be single-mode for signal light. The single-mode sapphire fibre may comprise a multi-mode waveguide. The cladding of the single-mode waveguide may provide the core of the multimode waveguide, and a second cladding may be provided surrounding the core of the multimode waveguide. The second cladding may be formed of air so that the boundary between the core of the multimode waveguide and the second cladding is provided by the sapphire-air boundary. Alternatively, the second cladding may be provided within the sapphire fibre. The multimode waveguide may be multimode for pump light. This has the advantage of allowing efficient coupling of pump lasers with divergent beams into the core/gain medium of the single-mode waveguide.

Therefore, according to another aspect of the invention there is provided an optical fibre comprising nested waveguides therein. The optical fibre may be a sapphire optical fibre, or any other suitable material. The nested waveguides may comprise an outer waveguide and an inner waveguide within the outer waveguide. The nested waveguides may comprise fabricated cladding (e.g. laser-fabricated cladding). The cladding of the inner-waveguide may be an optical core of the outer waveguide, and the outer waveguide may be for pumping the inner waveguide. The optical fibre may comprise any of the features described herein with reference to any aspect of the invention.

The single-mode sapphire fibre may comprise a sapphire optical fibre with an optical waveguide along its length. The optical waveguide may be a depressed cladding waveguide or a microstructured waveguide or a photonic crystal waveguide. The waveguide may be etched. The waveguide may have air-holes. The waveguide may be formed by irradiation. The waveguide may be off-centre within the fibre cross-section. The sapphire fibre may have more than one waveguide. The fibre may be a double-clad waveguide. There may be a single-mode waveguide within a multimode waveguide. The single-mode waveguide may be offset within the multimode waveguide. The multimode waveguide cross-section may be substantially round, square, rectangular, hexagonal, triangular, pentagonal, heptagonal, octagonal or rounded versions thereof. The waveguide or waveguides may be written with a femtosecond laser. The signal wavelength may be more tightly confined than the pump wavelength. The pump wavelength may be confined at the sapphire-air interface. A combiner may be used to combine the signal wavelength and the pump wavelength. The combiner may be a dichroic mirror.

The coupler may be a waveguide coupler within the sapphire fibre.

The signal wavelength may be coupled into the single-mode waveguide and the pump wavelength may be coupled into the multimode waveguide. There may be more than one pump laser. The signal wavelength and the pump wavelength may be co-propagating, counter-propagating or both. The signal or laser wavelength may be at 1064 nm or 1550 nm. The signal, laser or pump wavelength may be in the O-, E-, S-, C- or L-bands. The signal, laser or pump wavelength may be in the near infrared, mid infra red, visible or ultra violet. The length of single-mode fibre may be greater than one of 1 cm, 2 cm, 5 cm, 10 cm, 50 cm, 1 m, 1.5 m or 2 m. The pump laser may be an argon ion laser, an Nd:YAG laser, a semiconductor laser, or a diode laser. There may be a tilted and/or chirped Bragg grating.

The ‘double clad’ type approach to separately but collinearly guide pump laser light and signal laser light can contribute to uncoupling output power achievable from a Ti:Sapphire laser from the spatial brightness of the pump.

According to another aspect of the invention there is provided a master-oscillator power amplifier (MOPA) in which a sapphire fibre is an amplifier (e.g. without feedback) used to boost a high quality seed from a diode laser or a semiconductor laser (such as distributed feedback laser (DFB), distributed Bragg reflector (DBR) laser, Fabry-Perot lasers or external cavity diode laser). The MOPA may comprise a chain of amplifiers. This aspect may comprise any of the feature of the invention as recited herein with reference to any other aspect of the invention.

According to another aspect of the invention there is provided a laser, the laser comprising: an optical gain element according to the further aspect of the invention and a feedback element. This aspect may comprise any of the feature of the invention as recited herein with reference to any other aspect of the invention. The feedback element may comprise one or more reflectors. The feedback element may comprise one or more reflectors formed at a sapphire-air interface. The feedback element may comprise one or more reflectors which are thin-film coatings. The feedback element may comprise one or more Bragg gratings. The Bragg gratings may be within the single-mode waveguide. The Bragg gratings may be single-mode fibre Bragg gratings. There may be one or more tunable Bragg gratings. The tunable Bragg grating or gratings may be tuned by temperature, strain, voltage or current. The feedback element may comprise one highly reflective reflector and one partially reflective reflector. The feedback element may comprise one highly reflective Bragg grating and one partially reflective Bragg grating. The feedback element may comprise a diffraction grating. The angle of the diffraction grating may adjustable and the output of the laser may therefore be tuneable. The laser may comprise a seed laser to seed the optical gain element. The seed laser may be tunable. The laser may emit light at substantially a single wavelength. The laser may be within a spacecraft or a nuclear reactor.

The laser may be mode-locked. The laser may be actively mode-locked. The laser may be passively mode-locked. The laser may comprise an optical modulator. The laser may comprise an acousto-optic modulator. The laser may comprise a saturable absorber. These features have the advantage of allowing very short optical pulses to be generated.

According to another aspect of the invention, there is provided a sensor system, the sensor system comprising an optical gain element according to any aspect of the invention, wherein the single-mode sapphire fibre has at least one Bragg grating sensor. The Bragg grating may be tuneable e.g. by temperate or stretching. Any suitable type of tuning may be used. This aspect may comprise any of the features of the invention as recited herein with reference to any other aspect of the invention.

According to another aspect of the invention there is provided a single-mode sapphire optical fibre which is doped. The doped fibre may provide the optical gain element according to the first aspect of the invention. This aspect may comprise any of the features of the invention as recited herein with reference to any other aspect of the invention.

According to another aspect of the invention there is provided a method of amplifying an optical signal, the method comprising: providing a single-mode sapphire optical waveguide; injecting pump light into the optical waveguide. This aspect may comprise any of the features of the invention as recited herein with reference to any other aspect of the invention.

According to another aspect of the invention there is provided a method of providing laser light, comprising the method according to any aspect of the invention, the method further comprising: providing a feedback element and injecting a level of pump light above a threshold power level. This aspect may comprise any of the features of the invention as recited herein with reference to any other aspect of the invention.

According to another aspect of the invention there is provided an optical gain element comprising a multimode sapphire fibre coupled to a pump laser, wherein the multimode sapphire fibre comprises a single-mode waveguide. This aspect may comprise any of the features of the invention as recited herein with reference to any other aspect of the invention.

According to another aspect of the invention there is provided a polarisation maintaining single-mode sapphire optical fibre. There may be a single mode waveguide within a sapphire optical fibre. The waveguide may have an asymmetry in its cross-section. For example, the core may be elliptical or otherwise asymmetric. There may be stress-inducing structures within the cladding e.g. surrounding the single mode waveguide. This aspect may comprise any of the features of the invention as recited herein with reference to any other aspect of the invention.

The single-mode waveguide may support predominantly a single transverse mode. However, there may be other modes which although exist, exhibit high loss. For example, these may be due to having a depressed cladding of a finite diameter. For example, the other modes may have 10 times the loss of the predominant single-mode.

According to another aspect of the invention, instead of a single-mode sapphire optical waveguide, a few-mode, reduced-mode, or restricted-mode sapphire waveguide may be used in its placed. That is, the invention also provides any of the aspects as recited herein but comprising a reduced-mode waveguide in place of a single-mode waveguide. While the use of a single-mode waveguide is typically preferred, many of the advantages also extend to waveguides that permit more than just a single mode. The few-mode sapphire waveguide may have less than 1000 modes or less than 100 modes or less than 20 modes or less than 10 modes or less than 5 modes or less than 3 modes. The aspect may comprise any of the features of the invention as recited herein with reference to any other aspect of the invention, except that a reduced-mode (i.e. a few-mode) waveguide may be used in place of the single-mode waveguide recited in respect of those aspects. For example, the waveguide may be configured to suppress the propagation of some modes (e.g. higher order modes) but may nevertheless permit the propagation of a more than a single mode therein, e.g. several modes.

References herein to single-modes are intended to include single modes comprising multiple polarisation states. References herein to modes are intended to include modes comprising a predetermined wavelength or range of wavelengths. The term ‘sapphire’ is said to encompass doped sapphire and impure sapphire and Al₂O₃.

For optimal efficiency of stimulated emission of light using the single-mode sapphire optical waveguide (and indeed for optimal efficiency of stimulated emission of light using optical waveguides of any composition e.g. within single-crystal fibres according to another aspect of the invention), pump light would only be absorbed in the active waveguide and not wasted by being absorbed in active material surrounding the waveguide. However, cheap pumps are divergent and couple into a wide area surrounding the waveguide. Since it is difficult to only dope the core of the waveguide, light from cheap pumps may couple into active (i.e. doped) material surrounding the waveguide. By providing multiple cores within a doped region, more efficient use of the absorbed pump power can be achieved. The light emitted by individual cores can then be coherently combined to form a single output with higher power.

The optical fibre may comprise a plurality of single-mode sapphire optical waveguides. Each of the waveguides of the plurality of single-mode sapphire optical waveguides may comprise any of the aspects of the single-mode sapphire optical waveguide discussed herein. In particular, each of the waveguides of the plurality of single-mode sapphire optical waveguides may be a depressed cladding wave guide, may be a multi-layer depressed cladding waveguide (e.g. comprising a plurality of layers of modified fibre material providing multiple layers of cladding), or may be a photonic crystal waveguide (e.g. comprising a cladding comprising a periodic array of regions within the cladding having a modified index).

The plurality of single-mode sapphire optical waveguides may be in parallel, may be adjacent each other, and/or may be arranged to comprise a majority of the cross-section of the optical fibre. For example, three waveguides may be arranged in a triangle within the cross-section of the fibre. Seven waveguides may be arranged in the cross-section of the fibre so that six of them are distributed in a hexagonal pattern about a central waveguide. The plurality of waveguides may be arranged in a close packed hexagonal manner, within the cross-section of the optical fibre. Such an arrangement may be particular useful in a fibre with a hexagonal cross-section. In general, any suitable number of parallel waveguides may be used, and the waveguides may be arranged to comprise as much of the cross-section of the optical fibre as possible. The waveguides may be arranged to comprise as much doped material in the fibre as possible.

The waveguides may each have respective and distinct cladding, or they may share a common cladding. Each waveguide may comprise an unmodified portion of the fibre surrounded by cladding.

Each of the plurality of single-mode sapphire optical waveguides may comprise a Bragg grating, or a plurality of Bragg gratings. Each of the single-mode sapphire optical waveguides of the plurality of single-mode sapphire optical waveguides may comprise an optical cavity by providing a feedback device within the single-mode sapphire optical waveguide. The feedback device may be a pair of opposed Bragg gratings, or any suitable device.

The pair of Bragg gratings within each single-mode sapphire optical waveguide may be at the same or overlapping wavelengths as the pair of Bragg gratings within other waveguides of the plurality of waveguides. The optical fibre may therefore be configured to provide a single coherent output from the plurality of waveguides. The optical fibre may comprise an optical coupler (such as a directional coupler or an evanescent coupler) operable to combine the outputs of each of the waveguides of the plurality of single-mode sapphire optical waveguides. There may be provided with the optical fibre one or more phase shifter operably linked to one or more waveguides. For example, each additional waveguide may have a respective phase shifter associated therewith and operable to help combine the outputs of the plurality of waveguides into a single fibre.

Alternatively, the Bragg gratings of each of the waveguides of the plurality of single-mode sapphire optical waveguides may be at different wavelengths to the Bragg gratings in the other waveguides of the plurality of single-mode sapphire optical waveguides within the optical fibre. A series of different wavelength light may then be generated by the optical fibre.

The light from each waveguide may exit the sapphire optical fibre and enter one of a corresponding plurality of supplementary fibres. Some or each of the supplementary fibres may comprise, or be in operable communication with, a phase shifter before a coupler couples the light from each of the supplementary fibres into a single output fibre. The phase shifters may therefore alter the phase of the light in the respective supplementary fibres so that constructive interference of the light produces a single output beam with increased power.

In some embodiments, including those where a plurality of single-mode sapphire optical waveguides are provided, bulk sapphire may be used in place of the optical fibre. For example, a planar sapphire substrate may be used and comprise the plurality of single-mode sapphire optical waveguides.

According to another aspect of the invention, instead of sapphire, another hard crystal may be used. For example, diamond may be used in place of sapphire. That is, the invention also provides any of the aspects as recited herein but comprising a different optical fibre material in place of a sapphire optical fibre. While the use of sapphire optical fibre may be preferred, many of the advantages of the invention also extend to optical fibres comprising other material. Thus, the aspect may comprise any of the features of the invention as recited herein with reference to any other aspect of the invention, except that another fibre (e.g. a fibre comprising: material comprising a high sapphire (Al₂O₃) content, diamond, yttrium aluminium garnet (YAG, Y₃Al₅O₁₂), germanosilicate, borosilicate, or lithium niobate (LiNbO₃)) may be used in place of a sapphire fibre recited in respect of those aspects.

According to another aspect of the invention, there is provided a method of stimulating emission of light, comprising using a single-mode crystal optical waveguide as a gain medium. The crystal may be in an optical fibre, and may provide the optical fibre. The crystal may be a single crystal. Thus, the method may comprise stimulating emission of light, comprising using a single-mode single-crystal waveguide as a gain medium, wherein the single-mode single-crystal waveguide is provided within an optical fibre. Viewed from another aspect the invention provides an optical device comprising an optical gain medium comprising a single-mode crystal optical waveguide, and may comprise a single-mode single-crystal optical waveguide. Viewed from another aspect the invention provides a single-mode crystal optical waveguide, and may provide a single-mode, single-crystal optical waveguide. Viewed from another aspect the invention provides an optical fibre comprising a single-mode crystal optical waveguide. The optical fibre may comprise a single-mode, single-crystal optical waveguide i.e. a single-mode waveguide within a single-crystal fibre. Thus, according to these aspects of the invention the fibre is a crystal fibre (e.g. a single-crystal fibre) with the waveguide(s) therein. The fibre may comprise other materials such as cladding, but the portion of the fibre comprising the waveguide(s) may be crystal and/or single-crystal.

The single-crystal material may be monocrystalline. It may be material in which the crystal lattice of the entire sample (e.g. fibre) is continuous and unbroken to the edges of the sample, i.e. no portion of the material of the sample (e.g. fibre) is separated from another portion of the material of the sample by a grain boundary.

The single-mode crystal optical waveguide may be used in place of the single-mode sapphire optical waveguide recited in respect of any of the aspects discussed herein and described in relation the figures below. Thus, the single-mode crystal waveguide may comprise any of the features described herein with reference to any aspect of the invention. The optical fibre and/or waveguide may be as described herewith with respect to any other aspect except that instead of sapphire another suitable material may be used, for example any material suitable for use as an optical fibre, and/or as a gain medium. In particular, instead of sapphire any single-crystal material may be used.

The crystal may comprise diamond, or a silicate mineral, or an oxide mineral, or a phosphate, or a carbonate, or a halide. The crystal may comprise an aluminium silicate such as garnet, for example yttrium aluminium garnet (YAG), lutetium aluminium garnet (LuAG). The crystal may comprise an aluminium oxide such as corundum (e.g. sapphire or ruby) or CaGdAlO₄ (CAlGO). The crystal may comprise zirconium dioxide (zirconia). The crystal may comprise any material suitable for use in as an optical fibre.

The single-mode crystal optical waveguide may be doped. The single-mode crystal optical waveguide may be doped with titanium. The single-mode crystal optical waveguide may be doped with a rare earth element. The single-mode crystal optical waveguide may be co-doped with two or more elements. The single-mode crystal optical waveguide may be doped with any one or more of: titanium, ytterbium, erbium, neodymium, thulium, praseodymium, palladium, holmium, chromium, cobalt, iron, magnesium, manganese, nickel, carbon or zinc. These have the advantage of allowing optical gain within the crystal. The single-mode crystal optical waveguide may therefore be doped in order to provide a gain medium.

In particular, the single-mode crystal optical waveguide may comprise ytterbium doped yttrium aluminium garnet.

According to another aspect of the invention, there is provided an optical device comprising a crystal fibre, the crystal fibre comprising a plurality of waveguides therein. The crystal fibre may be a single-crystal fibre. The invention may comprise using the optical device as a gain medium. The waveguides may be adjacent each other and may be in parallel e.g. guiding light within the same length of the fibre. The fibre may therefore be a multicore, single-crystal fibre. One or more (or all) of the waveguides may be single-mode waveguides. The crystal may be sapphire or yttrium aluminium garnet (YAG) or any other suitable material. The crystal may be doped. The dopant may be a rare earth element. The dopant may be chromium and/or ytterbium, and/or any suitable dopant e.g. for use as a gain medium. The waveguides may be depressed cladding waveguides e.g. as described herein with reference to any aspect of the invention. The waveguides may be micro-structured waveguides e.g. as described herein with reference to any aspect of the invention.

The waveguides may be photonic crystal or photonic bandgap waveguides e.g. as described herein with reference to any aspect of the invention. The waveguides may be laser written. The waveguides may have Bragg gratings within them. The optical device and/or crystal fibre may comprise any of the features as recited herein with reference to any other aspect of the invention.

Although separate aspects of the invention are presented above, it will be appreciated that features described with reference to a particular aspect may be used in combination with any of the aspects as needed.

Exemplary embodiments of the invention will now be described by way of example only and with reference to the accompanying drawings in which:

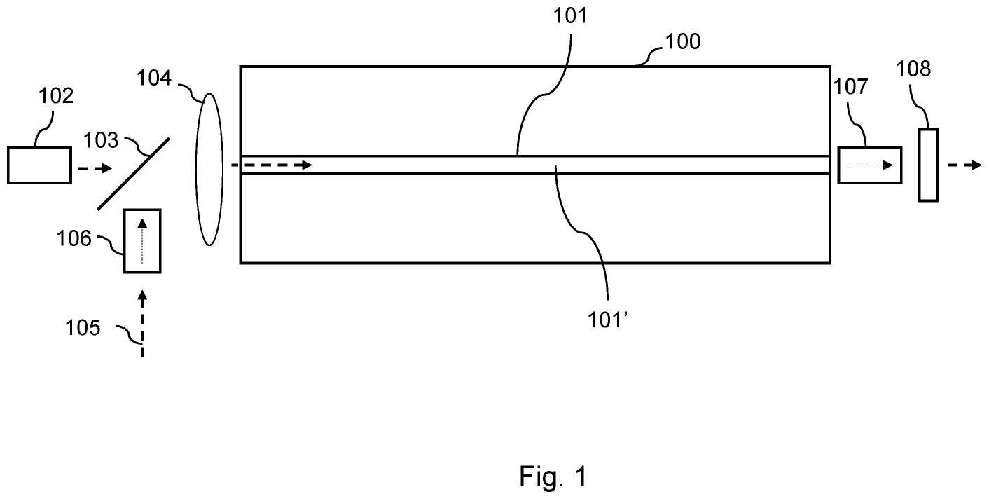

FIG. 1 shows a schematic of an optical device.

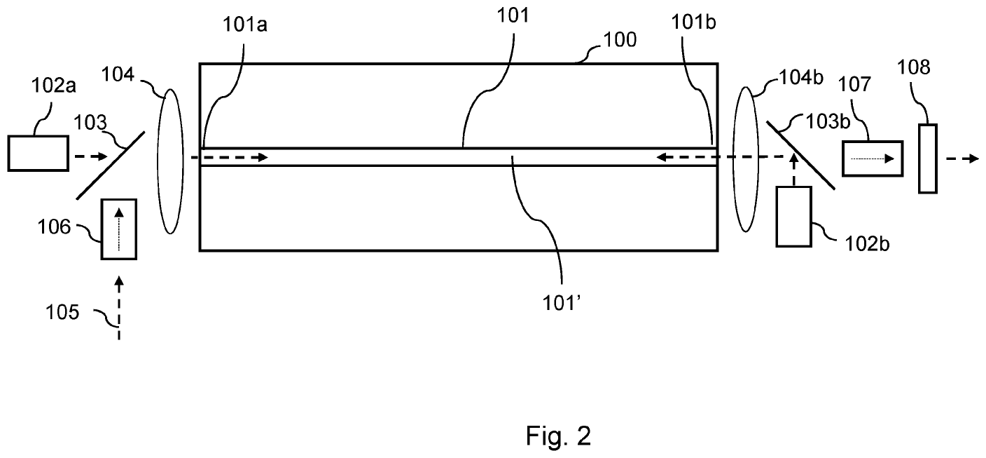

FIG. 2 shows an alternative schematic of an optical device.

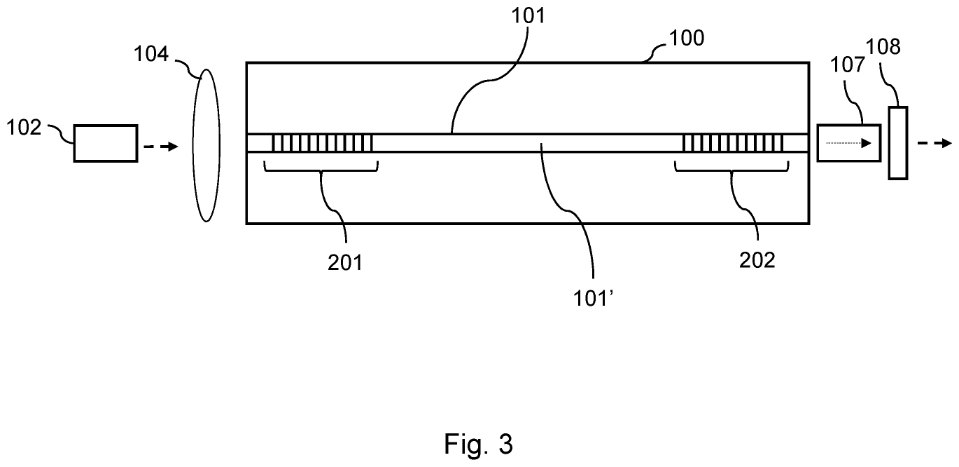

FIG. 3 shows an alternative schematic of an optical device.

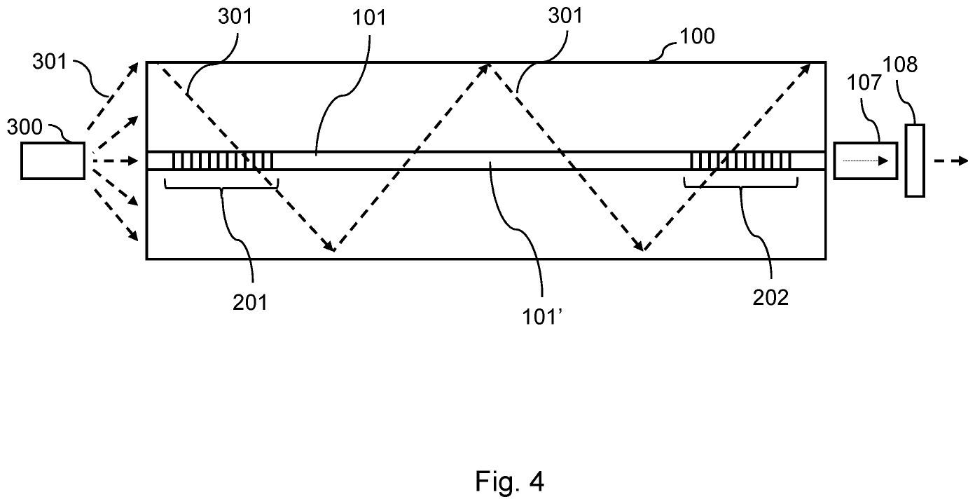

FIG. 4 shows an alternative schematic of an optical device.

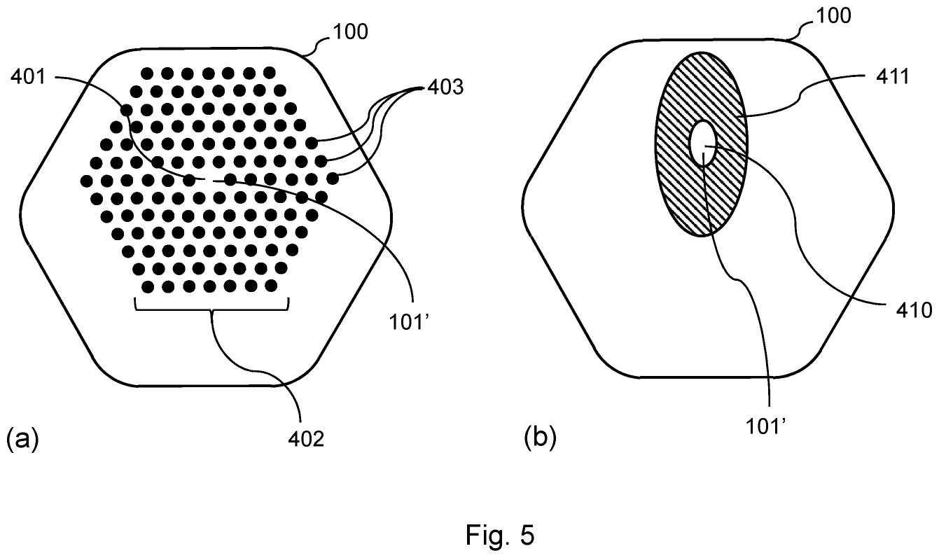

FIGS. 5a and 5b show schematic cross sections of alternative optical waveguide designs within an optical device.

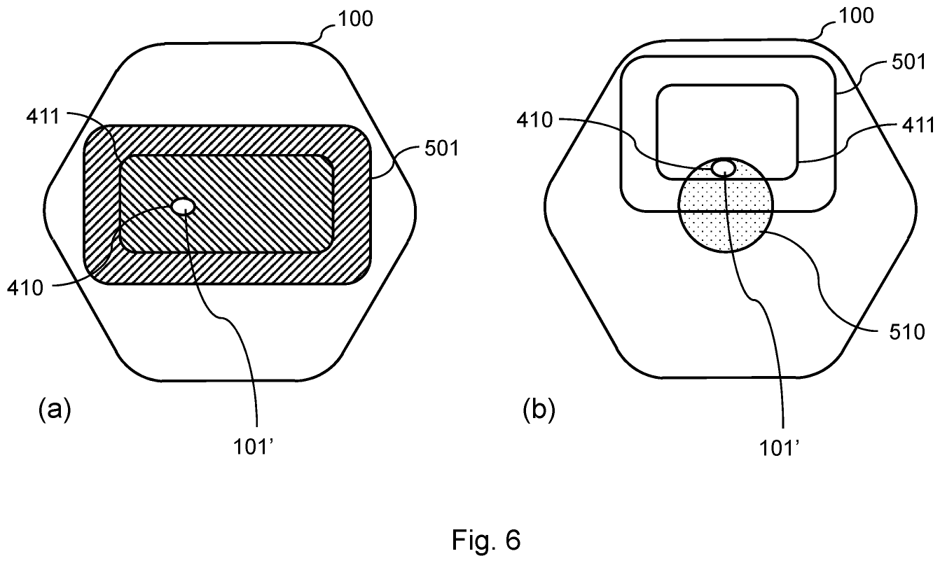

FIGS. 6a and 6b show schematic cross sections of alternative optical waveguide designs.

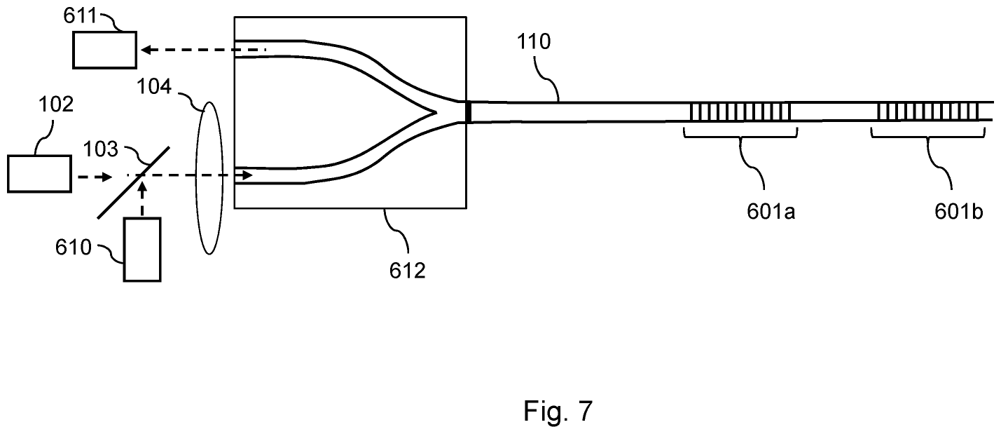

FIG. 7 shows a schematic of a sensor system.

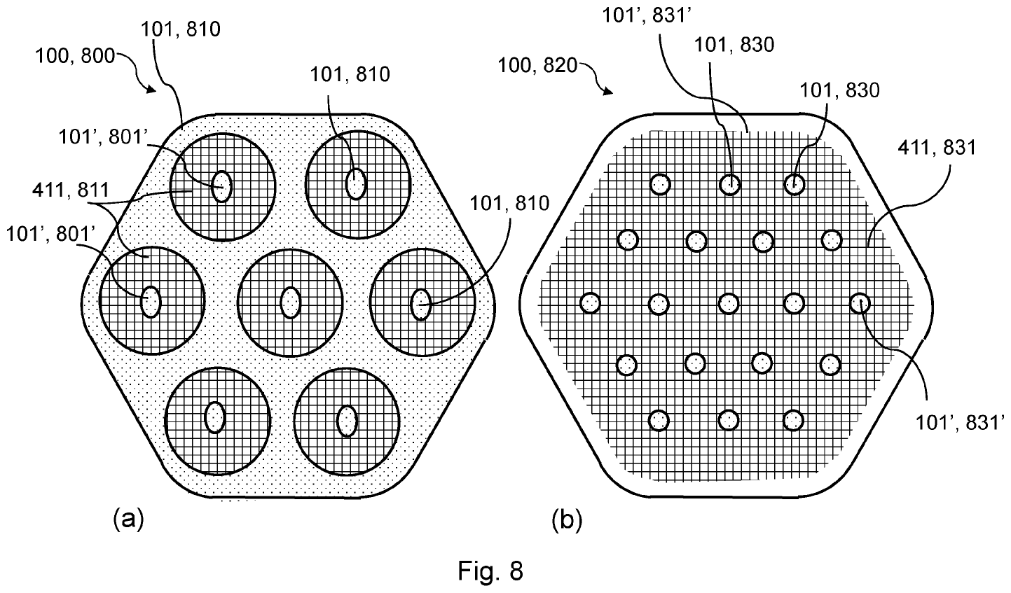

FIGS. 8a and 8b show schematic cross sections of optical devices comprising a plurality of optical waveguides.

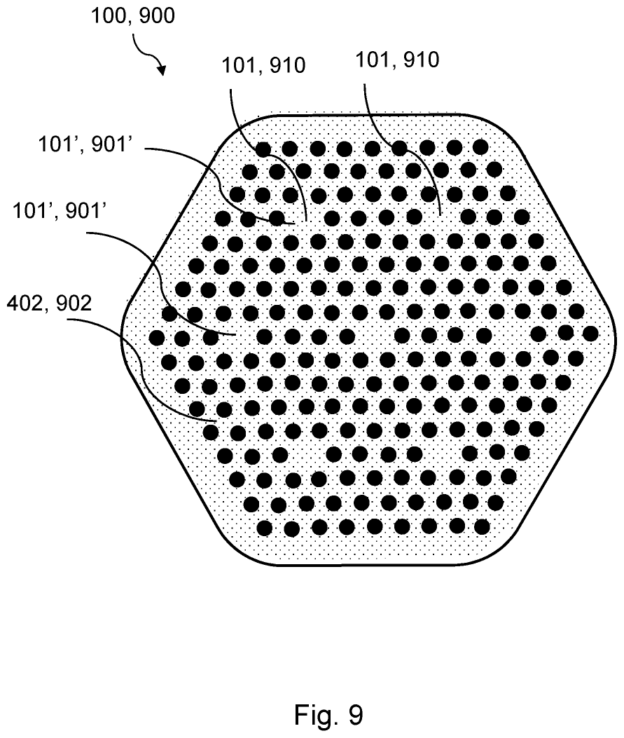

FIG. 9 shows a schematic cross section of an optical device comprising a plurality of optical waveguides.

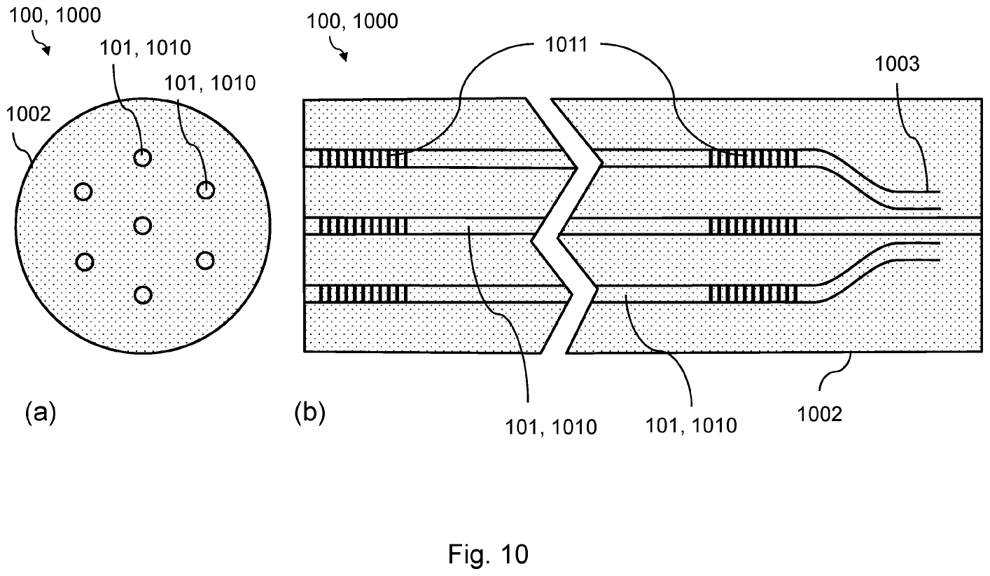

FIG. 10a shows a cross section of an optical device perpendicular to its longitudinal length.

FIG. 10b shows a cross section of the optical device of FIG. 10a parallel to its longitudinal length.

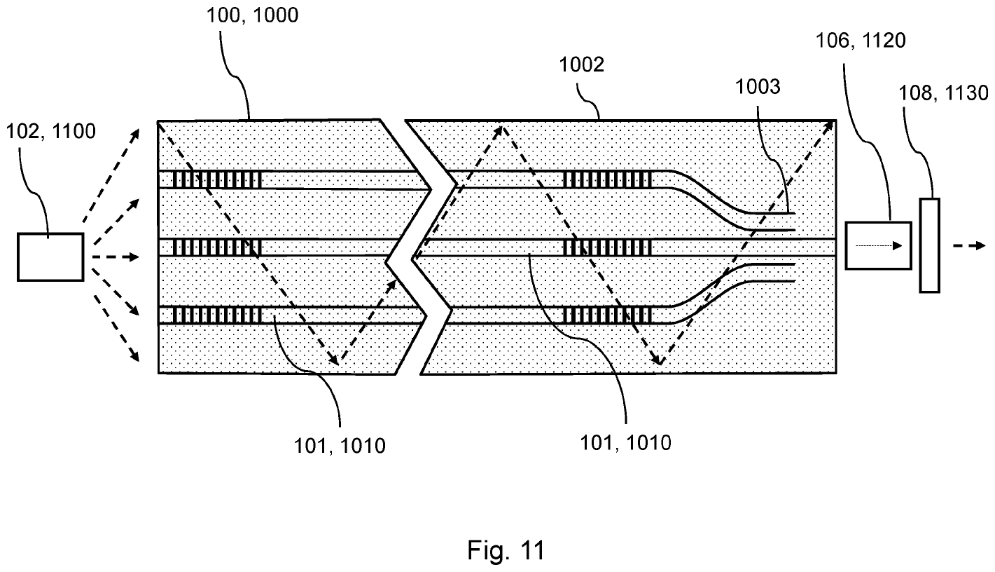

FIG. 11 shows a schematic of an optical device comprising a plurality of waveguides.

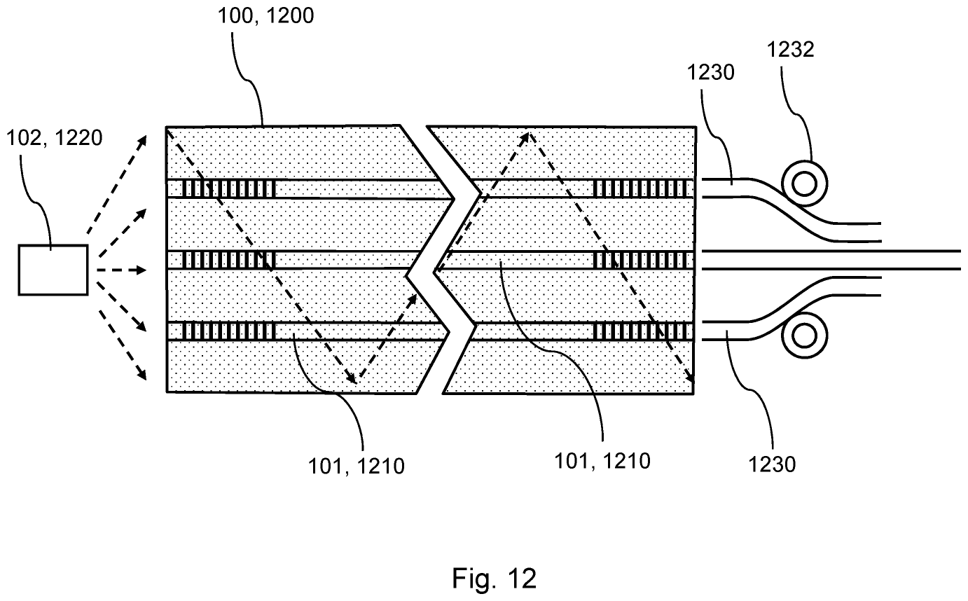

FIG. 12 shows a schematic of an alternative optical device comprising a plurality of waveguides.

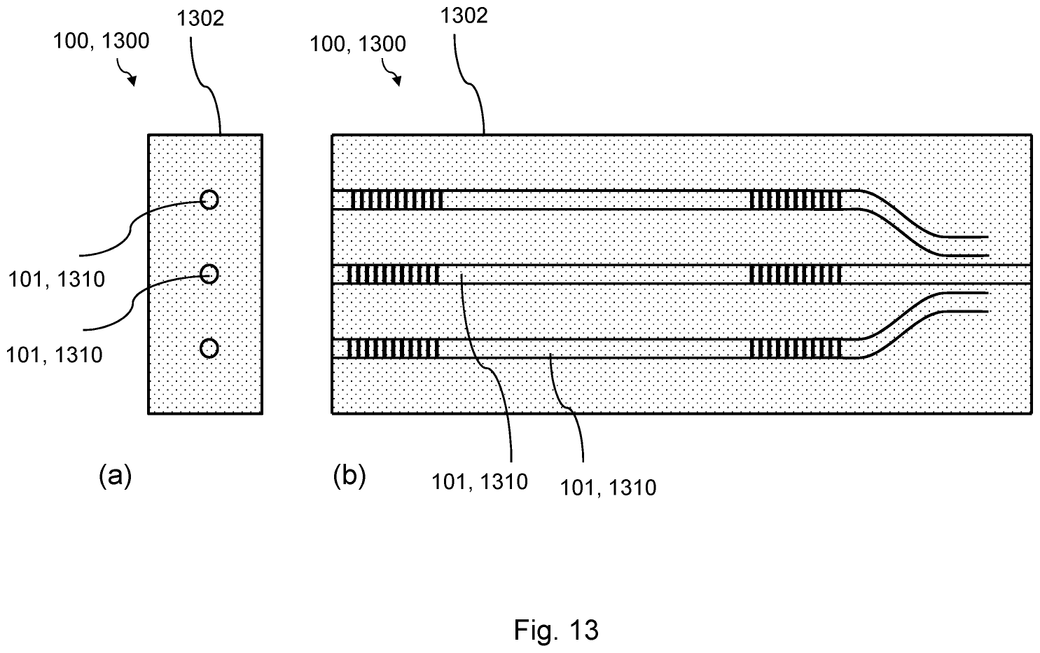

FIG. 13a shows a cross section of an optical device perpendicular to its longitudinal length.

FIG. 13b shows a cross section of the optical device of FIG. 13a parallel to its longitudinal length.

FIG. 1 shows a schematic of an apparatus comprising an optical device 100 arranged as a gain element. This figure and the subsequent figures are diagrammatic only and are not drawn to scale. The optical device comprises a sapphire optical fibre 100. Within the sapphire 100 there is a single-mode optical waveguide 101 provided along the length of the fibre 100. The single-mode sapphire optical waveguide 101 comprises an optical core 101′. The sapphire waveguide 101 is doped with titanium or an alternative dopant, such as chromium or any other doping element that enables the waveguide 101, to thereby act as a gain medium. This waveguide 101 may be written within the sapphire optical fibre 100 using a femtosecond laser, for example. This laser modification may cause a reduction in the refractive index of the sapphire within the regions exposed to the femtosecond laser. Alternatively, the waveguide 101 may be formed by another means, such as by irradiation causing modification to the exposed regions e.g. to form an inner cladding. The waveguide 101 may be provided by laser-modifying regions of the optical fibre 100 surrounding the core 101′ to thereby form cladding within the fibre 100 (see e.g. cladding 402 in FIG. 5a), and the unmodified core 101′ and the cladding may then co-operate to provide the waveguide 101.

When the optical device 100 is used to emit light, a pump laser 102 is used to excite ions in the waveguide 101 into a higher energy state. The pump laser 102 may be an argon ion laser at 514.5 nm or a frequency doubled Nd:YAG at 532 nm, for example. The pump laser may also be a diode laser. Any suitable means of pumping the gain medium may be used. Light from the pump laser 102 is injected into the waveguide 101 via a dichroic mirror 103 and a lens 104. Input light 105 enters through an input optical isolator 106 (for example a Faraday isolator) and reflects off the dichroic mirror 103. The input light 105 reflected from the dichroic mirror passes through the lens 104 and couples into the waveguide 101. The input light 105 causes stimulated emission of light from the excited ions within the waveguide 101, and specifically within the core 101′. The photons emitted in this way have the same wavelength as the input light 105. The emitted light is therefore amplified within the waveguide 101 by stimulation of the excited ions to emit photons at the same wavelength as the input light 105. The amplified light exits the waveguide 101 at an end of the fibre 100 and passes through an output optical isolator 107 (which may be the same type of isolator as the input isolator 106). The optical isolator 107 is configured to prevent emitted light being reflected back into the waveguide 101. Finally, any residual pump light is filtered out with a filter 108. Thus, in some uses of the optical device 100, the input light 105 is amplified within the waveguide 101.

In alternative embodiments of the invention, the optical device 100 may comprise bulk sapphire as an alternative to the sapphire optical fibre shown in FIG. 1. The single-mode optical waveguide may then be provided within the bulk sapphire.

FIG. 2 shows a configuration of the optical device 100 in which the waveguide 101 is pumped in both a forward and a backward propagation direction. That is, light from a first pump laser 102a enters the waveguide 101 at a first end 101a of the waveguide 101, and light from a second pump laser 102b enters the waveguide 101 at a second end 101b of the waveguide 101 opposite the first end 101a. Light from the second pump laser 102b is coupled into the waveguide 101 from the end 101b via a dichroic mirror 103b and a lens 104b. The waveguide 101 could alternatively be solely pumped from the backward direction, i.e. using the second pump laser 102b only. That is, the waveguide 101 may be used in either direction.

FIG. 3 shows a laser using the optical device 100 (e.g. as shown in FIG. 1) as the laser's gain medium. The laser therefore utilises the doped sapphire single-mode waveguide 101 as the gain medium. The waveguide 101 comprises Bragg grating reflectors 201, 202 within the core 101′ of the waveguide 101, forming a cavity within the waveguide 101 therebetween. The waveguide 101 is optically pumped with the pump laser 102. The Bragg gratings 201, 202 have a periodic variation in effective refractive index, such that the gratings reflect within a narrow wavelength range. This wavelength range falls within the gain window of the doped sapphire within the waveguide 101 and the optical core 101′. The Bragg gratings 201, 202 provide the feedback to enable laser operation. The Bragg grating 201 has a very high reflectivity, while the Bragg grating 202 can have lower reflectivity to allow light to be emitted from the end of the waveguide 101 and fibre 100. An optical isolator 107 prevents light being reflected back into the waveguide 101 and an optical filter 108 removes any pump light emitted. Alternatively, the laser may employ a backward propagating pump or co-propagating pump laser light, as illustrated in FIG. 2.

The laser system may comprise a grating (e.g. a Bragg grating) or gratings outside the optical fibre 100, and the angle of those gratings can be adjustable so that the output of the laser system may be tuned. The optical fibre 100 may comprise a single Bragg grating in the waveguide 101 as part of an optical cavity for laser generation, or reflectors may be provided external to the optical fibre 100.

In alternative embodiments of the invention, reflections of the light within the waveguide 101 can be provided by mirrors external the waveguide, or by the waveguide/air boundary at the entrance and/or exit of the waveguide. That is, any suitable optical cavity may be used, and the optical fibre 100 and waveguide 101 may comprise at least part of that optical cavity.

The Bragg gratings 201, 202 may also be employed as part of a sensor system, since the optical fibre 100 is sapphire and therefore highly durable, the fibre may be disposed in extreme environments, such as engines suitable for aerospace use. The fibre may be disposed in environments exposed to high levels of radiation, such as in nuclear reactors. The conditions to which the fibre is exposed may alter the configuration of the fibre, and particularly the configuration of the Bragg grating (or gratings, where more than one is present), thereby changing its optical properties. Thus, the configuration of the grating may be used to measure properties of the environment it is disposed in.

FIG. 4 shows another example of a laser. Due to the typically wide divergence angles of pump lasers it can be difficult to efficiently couple light from the pump laser into single-mode waveguides. However, the sapphire fibre 100 is naturally a multimode waveguide, with guiding taking place at the interface with the sapphire and the air (so that the air is effectively the cladding). A divergent pump laser 300 is used to launch pump light 301 into the multimode waveguide i.e. into the optical fibre 100. Higher order propagation modes of the pump light 301 can then be guided within the larger optical fibre 100, while a single mode of signal pump light 301 is guided along the core 101′ of the single-mode waveguide 101. The pump light 301 then overlaps with the single mode waveguide 101 and excites ions in the single-mode waveguide 101 to a higher energy state. Some of the excited ions within the single-mode waveguide will spontaneously decay back to a lower energy state, emitting a photon. These photons will stimulate further (phase coherent) photons to be emitted from the other excited ions within the single-mode waveguide. Feedback is provided by the two Bragg gratings 201, 202 which reflect light at a specific wavelength, resulting in a narrow spectrum.

There are numerous advantages associated with providing a single-mode waveguide within a multi-mode waveguide, as shown for example in FIG. 4. These include that a low spatial quality pump can be efficiently coupled into the single-mode waveguide. Also, power scaling can be achieved by coupling multiple pumps into the optical fibre. Further, the pump light mode and the laser light mode can have small mode radii which can be maintained over longer distances compared to those distance achieved when relying on diffraction, which in turn brings the threshold pump power down (for example, titanium doped sapphire has an ‘intrinsic’ threshold that, like for like, is about 50 times that of neodymium-doped yttrium aluminium garnet, a commonly used laser gain medium). Optically pumped lasers require a certain amount of pump power before any laser light is emitted. It is therefore desirable to have a lower threshold pump power. Further yet, the pump light can be guided such that pump absorption occurs over distances equivalent to a few absorption lengths in titanium-doped sapphire but without the detrimental effects of diffraction causing the mode radius to become unfeasibly large when integrated over this distance. These advantages assist in overcoming common drawbacks relating to doping level, pump beam quality, and minimum pump mode size that occur in bulk titanium-doped sapphire lasers.

FIG. 5 shows different implementations of forming the single mode waveguide in sapphire. FIG. 5(a) shows a cross-section of an optical device 100 comprising a micro-structured waveguide 401 (e.g. a periodic structure waveguide, a photonic-crystal fibre, a micro-void fibre, photonic bandgap fibre, or the like). The optical device 100 comprises a core 101′ of unmodified sapphire in the waveguide 401 and a micro-structured cladding 402, and there is therefore a periodic variation in refractive index over the cross-section of the optical device 100. The waveguide 401 is configured to suppress propagation of all but a single mode in the core 101′ by the cladding 402, and optical device 100 is a single-mode optical sapphire fibre 100. These fibres can be referred to as photonic crystal fibres or photonic bandgap fibres. The periodic structure can be formed by using a femtosecond laser to change (lower) the refractive index in the exposed regions 403. They could also be formed by using e.g. an etching process or as described in A. Ródenas et al. “Three-dimensional femtosecond laser nanolithography of crystals,” Nature Photonics 13, 105-109 (2019) https://doi.org/10.1038/s41566-018-0327-9, the contents of which are incorporated herein in their entirety. The inventor has discovered that the methods and features disclosed therein may be combined with features to the present invention.

FIG. 5(b) shows a cross-section of an optical device 100 comprising a depressed cladding single mode waveguide 410. The optical device 100 comprises a core 101′ of unmodified sapphire surrounded by a cladding 411. The cladding 411 has a reduced refractive index compared to the unmodified sapphire and is formed by exposing the sapphire of the cladding region to femtosecond pulses of laser light e.g. as described in GB1712640.0. The core 101′ therefore has a higher refractive index compared to the cladding 411 (for example the refractive index of the core 101′ may be between 5×10⁻⁴ and 5×10⁻² greater than that of the cladding 411). The cladding 411 therefore co-operates with the core 101′ to provide the waveguide 410. The cladding 402, 411, does not need to extend to the edges of the fibre 100, and therefore may be surrounded by unmodified sapphire.

It may be advantageous to make the diameter of the cladding 411 as large as possible to reduce radiative losses. In this example, the core 101′ has an elliptical cross section to form a polarisation maintaining optical waveguide 410. This can be particularly useful for maintaining the polarisation state when the optical fibre 100 is bent. The depressed cladding waveguides 410 could also be made using e.g. a method described in Wang et al., “Single-mode sapphire fiber Bragg grating,” Optics Express 30, 15482-15494 (2022) https://doi.org/10.1364/OE.446664, the contents of which are incorporated herein in their entirety. The inventor has discovered that the methods and features disclosed therein may be combined with features to the present invention.

In the optical devices of FIGS. 5(a) and 5(b), each of the cores 101′ respectively (and hence each of the waveguides 401, 410) is off-centre compared to the centre of the respective fibre cross sections shown. The sapphire surrounding the cores 101′ can act as a multimode optical waveguide. There are advantages in having the single mode waveguide off-centre within the multimode optical waveguide in that an increased proportion of the pump light provided to the multimode optical waveguide may be coupled into the single-mode optical waveguide 401, 410.

In alternative embodiments the waveguide may have a reduced cross-sectional symmetry in order to achieve similar advantages, providing an increase in pump light coupled into the gain medium of the core. For example, the cross section of the multimode waveguide may by D shaped.

Further, while it is possible to use the whole of the sapphire optical fibre 100 as a multimode fibre surrounding a single-mode fibre 101, 401, 410, the concept of having one waveguide within another can be taken a step further to provide nested, fabricated waveguides within the optical fibre 100.

FIG. 6 shows a single-mode waveguide 410 in sapphire optical fibres 100 formed using alternative methods. FIG. 6(a) shows a cross section of an optical device 100 formed of a sapphire optical fibre 100 in which there is an inner single-mode waveguide 410 comprising a core 101′, a first cladding 411 surrounding and adjacent to the core 101′ of the waveguide 410 and a second, outer cladding 501 surrounding and adjacent to the first cladding 411. The first cladding 411 has a refractive index which is lower than that of the core 101′, while the second cladding 501 has a refractive index which is lower than that of the first cladding 411. Thus, two nested waveguides are provided, the first, single-mode waveguide provided by the core 101′ cooperating with the first cladding 411, and the second multimode waveguide provided by the first cladding 411 cooperating with the second cladding 501. In this example, multimode pump light is confined within the bounds of the second cladding 501 and propagates within the first cladding 411. That is, the first cladding 411 in effect provides the optical core of the second waveguide.

The first cladding 411 therefore provides the cladding to form the first, single-mode optical waveguide 410. The first cladding 411 also forms the ‘core’ of the second, multimode optical waveguide by co-operation with the second cladding 501. The cladding for the second, multimode optical waveguide is provided by the second cladding 501. The laser-modified sapphire forming the second cladding 501 may be formed by exposing the sapphire within the region to larger doses of the femtosecond laser (e.g. at a higher pulse energy, and faster repetition rate) compared to the sapphire within the region of the first cladding 411 so that the second cladding 501 has a lower refractive index than the first cladding 411.

The same advantages described above in relation to the arrangement depicted in FIG. 4 can also apply to the nested waveguide arrangement shown in FIG. 6. Multimode light propagating in the outer waveguide can be used to pump the gain medium of the core 101′ of the inner (single-mode) waveguide.

The optical device 100 comprising a multimode waveguide and a nested single-mode waveguide as described above can be referred to as a cladding pumped optical device 100, or cladding pumped optical waveguide 101. It is desirable for the cladding pumped optical waveguide to ensure that only the core is doped, since if the first cladding (i.e. the optical core or the cladding pumped waveguide) is doped it may absorb the pump power without contributing to optical gain. A method of selectively doping sapphire fibres to form an inner core of doped material is described in V, N, Kurlov et al., “Growth of sapphire core-doped fibers,” Journal of Crystal Growth 191(3) 520-524 (1998), the contents of which are hereby incorporated in their entirety. The inventor has discovered that the methods and features disclosed therein may be combined with features to the present invention. However, it is challenging to constrain the doped region to just be in the single mode optical waveguide core 101′, at least because that core is very small.

FIG. 6(b) shows a cross section of an optical device 100 formed of a sapphire optical fibre 100 which has a doped region 510 which has been selectively doped with Ti³⁺. This doped region 510 therefore has the ability to act as a gain medium. There is a core 101′, and a first cladding 411 surrounding and adjacent the core 101′ to thereby provide the waveguide 410, and a second cladding 501 surrounding and adjacent the first cladding 411. The core 101′ is off-centre within the cladding 411. The areas of the core 101′, first cladding 411, second cladding 501, and doped region 510, are designed to minimise the overlap of the gain area (i.e. the doped region 510) with the first cladding 411 which forms the core of the multimode waveguide. Thus, the overlap of multiple propagation modes in the pump waveguide (i.e. in the first cladding 411) with the doped region 510 is reduced (or even minimised). Hence, the loss of energy by pump modes exciting gain material outside the core 101′ of the single-mode waveguide is reduced. The shape of the doped region 510 may be configured to maximise the overlap with the optical core 101′ of the single-mode waveguide while minimising the overlap with the first cladding 411. For example, the doped region 510 of the fibre may have an elliptical cross-section, a rectangular cross-section, or any suitable shape.

The cladding of the single-mode sapphire optical fibre may therefore comprise a doped portion and a non-doped portion. The majority of the cladding of the single mode waveguide may be non-doped. The fibre may comprise a doped region outside the cladding.

The method may include modifying the optical fibre 100 so that the core 101′ is at an edge of the doped region 510, to thereby improve efficiency by reducing the loss of pump power in regions outside the core 101′ of the single mode waveguide 101, 410.

There are numerous types of laser which could be fabricated or provided using the doped single-mode sapphire fibre as recited herein. The laser could be passively mode locked (e.g. with a saturable absorber) or actively mode-locked (e.g. with a modulator). The laser could be a narrow bandwidth laser or a single frequency laser. The laser could be diode pumped (e.g. with a DFB or DBR semiconductor laser). The laser could be a Master Oscillator Power Amplifier (a laser followed by an amplifier). The laser maybe injection-locked with light from a seed laser. The laser could be for applications such as gas sensing and quantum technology. The laser could be a wavelength swept laser, and could be used for applications such as optical coherence tomography. There are many configurations possible (e.g. ring laser, figure of eight). It would be beneficial to make the single mode sapphire optical fibre polarisation maintaining to avoid the need for polarisation control.

FIG. 7 shows a sensor system which uses a single mode sapphire optical fibre 100 in which the single mode waveguide is used as a gain medium to mitigate propagation losses. The system has a length of sapphire fibre 100 comprising a waveguide 110 along its length with a series of fibre Bragg gratings (601a, 601b etc.) provided along the length of the waveguide 110. The sapphire waveguide 110 is doped with Ti³⁺ so that the sapphire waveguide 110 may act as a gain medium (thereby acting to reduce the waveguide loss). The sapphire fibre 100 is excited by pump laser 102. The Bragg gratings 601a, 602b are each at a different wavelength and are sensitive to temperature. The wavelength of each Bragg grating 601a, 601b (e.g. the centre wavelength of the Bragg reflection spectrum) is determined by scanning a tuneable laser 610. The light reflected from the Bragg gratings 601a, 601b is directed onto photodetector 611 via splitter 612. The splitter may be a separate silica coupler (e.g. a fused silica coupler) or a waveguide splitter in the sapphire (e.g. a Y splitter, multimode interference coupler) or a separate optical circulator. The Bragg grating is a sensor. For example, strain or temperature in the vicinity of each Bragg grating will change its wavelength. The laser 610 can be tuned (swept) in wavelength to measure what the centre wavelength of each Bragg grating is, and therefore use the depicted arrangement as a sensor system.

Instead of using FBGs, distributed sensing may be used incorporating the sapphire optical device according to any aspect of the invention, for example sensing based on backscattered light. The sensors may be based on Rayleigh, Brillouin, or Raman scattering.

FIG. 8a shows a cross-section of an optical device 100, 800 comprising a plurality of depressed cladding single mode waveguides 810. The waveguides are therefore arranged in parallel within the optical fibre. The optical device 100, 800 comprises a plurality of cores 101′, 801′ of unmodified sapphire each surrounded by a respective cladding 411, 811 which has been modified to comprise a reduced refractive index compared to the unmodified sapphire core 101′, 801′. In this example, the cores 101′, 801′ are elliptical so that the waveguides are polarization maintaining. In this example, the majority of the sapphire has been doped as indicated by the dots throughout the cross section of the figure. Selective doping of the sapphire is difficult, and it can be easier or preferable to dope a larger area of the optical device 100, 800, or even the whole fibre. By providing a plurality of waveguides within such an optical device 100, 800, the efficiency loss due to pump light coupling to gain medium, i.e. doped sapphire, outside of the waveguides can be minimised. The waveguides are arranged in a close packed configuration in order to maximise coverage within the fibre. In this example, seven waveguides 101, 810 are provided in a close packed configuration to form a hexagon shape.

FIG. 8b shows another example of an optical device 100, 820 comprising a plurality of depressed cladding single-mode waveguides 101, 830. However in this example, the majority of the sapphire between the cores 101′, 831′ has been modified to form the cladding 411, 831 for each waveguide 101, 830 which comprises a reduced refractive index compared to the unmodified sapphire of the cores 101′, 831′. Thus, the waveguides share a common depressed cladding.

The description of the depressed cladding waveguide 410 of FIG. 5b is applicable to each of the waveguides 101, 810, 830.

FIG. 9 shows a cross section of an optical device 100, 900 comprising a plurality of micro-structured waveguides 101, 910 (e.g. a periodic structure waveguide, a photonic-crystal fibre, a micro-void fibre, photonic bandgap fibre, or the like). The optical device 100, 900 comprises a plurality of cores 101′, 901′ of unmodified sapphire and a micro-structured cladding 402, 902 (e.g. a periodic array of laser modified regions) such that there is therefore a periodic variation in refractive index over the cross-section of the optical device 100, 900. In this example, the majority of the sapphire between the cores 101′, 901′ has been modified to form the cladding 402, 902 for each waveguide 101, 910 and cores are formed where there is a gap in the microstructure.

The description of the micro-structured waveguides 401 of FIG. 5a is applicable to each of the waveguides 101, 910.

FIG. 10(a) shows an optical device 100, 1000 comprising a fibre 100, 1002 shown in cross section perpendicular to a longitudinal length of the fibre. The optical device 100, 1000 comprises a plurality of waveguides 101, 1010, for example those of FIGS. 8(a), 8(b), and/or 9.

FIG. 10(b) shows the optical device 100, 1000 in cross section parallel to the longitudinal length of the fibre. Each waveguide 101, 1010 comprises a pair of Bragg gratings 1011, one at either end of the waveguide, to provide feedback.

Each pair of Bragg gratings 1011 can be at the same Bragg wavelength as the other pairs of Bragg gratings 1011 in order to provide a single coherent output from the optical device 100, 1000. The output from each waveguide 101, 1010 is coherently combined with an optical coupler 1003 (directional coupler or evanescent coupler). In this example, the optical coupler is formed within the fibre 1002.

Preferably, the light from each waveguide should be in phase such that when the light is combined, constructive interference takes place. In some examples, one or more of the waveguides may be operably connected to a phase shifter (e.g. a thermal phase shifter or the like). They may alternatively be passive or passively trimmed. The fibre may be fixed in position, e.g. so that it will not bend, e.g. to avoid the phase between waveguides from changing. The phase of the light within the waveguide may be controlled by modifying either the length of the waveguide or by modifying the “effective refractive index” of the waveguide. The effective refractive index depends on the core dimensions and the refractive index difference between the core and the cladding. For example, the effective refractive index of one or more of the waveguides may be modified by: laser writing lines down the (originally unmodified) core to reduce the core's refractive index; laser writing rings around the core; and/or, laser modifying the cladding (e.g. “overwrite the cladding”) to reduce the cladding's refractive index further. Thus, the optical device comprises an optical coupler configured to combine the light from the plurality of waveguides into a reduced number of waveguides e.g. into a single waveguide.

Instead of having every pair of Bragg gratings at the same wavelength, each waveguide may have a pair of Bragg gratings at a different wavelength, to allow generation of a series of different wavelengths. Any suitable configuration of Bragg gratings may be provided as required.

FIG. 11 shows the optical device 100, 1000 of FIGS. 10(a) and 10(b) in use as a laser. The optical device 100, 1000 comprises a plurality of parallel waveguides within a single optical fibre. Light from at least one pump laser 102, 1100 is injected into each of the waveguides 101, 1010 in order to excite ions in the waveguides 101, 1010. All of the parallel waveguides may be pumped using the same pump laser 102, 1100 in order to exploit as much power from the pump laser 102, 1100 as possible. Input light causes stimulated emission of light from the excited ions within the waveguides 101, 1010. Light emitted from the waveguides is coupled within the fibre 100, 1000 into a single waveguide to form a laser output which is provided to an isolator 106, 1120 and a filter 108, 1130 to filter pump light from the laser output.

FIG. 12 shows another optical device 100, 1200 comprising multiple waveguides 101, 1210 in a single fibre in use as a laser. Light from at least one pump laser 102, 1220 is injected into each of the waveguides 101, 1210 in order to excite ions in the waveguides 1210. All of the parallel waveguides may be pumped using the same pump laser 102, 1220. The output of each waveguide 101, 1210 is provided to a supplementary optical fibre 1230. One or more of the supplementary fibres 1230 is provided in operable communication with a phase shifter 1232. A plurality of phase shifters 1232 can be provided so that each phase shifter 1232 is dedicated to only one supplementary fibre 1232. Since it may be difficult to maintain phase control within and between the waveguides of the optical fibre, the phase of each phase-shifter 1232 can be independently adjusted in order to ensure the light output from each waveguide 101, 1210 is in phase and constructively interferes to produce a single output beam with higher power (e.g. increased power compared to a fibre within only a single waveguide therein).

FIGS. 10(b), 11 and 12 include a jagged break within the fibre 1002 and 1202 to truncate the image, but the fibre is continuous between the Bragg gratings and may extend longer than that shown in the image. Any suitable length of fibre may be used. The images are of course merely schematic for the purpose of illustrating concepts.

FIGS. 13(a) and 13(b) show an optical device 100, 1300 comprising a planar substrate 1302 which extends in a longitudinal direction. FIG. 13(a) shows a cross section of the optical device 100, 1300 perpendicular to its longitudinal length, and FIG. 13(b) shows a cross section of the optical device 100, 1300 parallel to the longitudinal length. The planar substrate comprises a plurality of waveguides 101, 1310 each comprising a pair of Bragg gratings 1320, and a coherent coupler 1330. A material of any suitable shape may be used, and although optical fibre has associated advantages, materials with other shapes may also be used and have associated advantages.

The optical device 100, 1300 may be used as a laser, in which case pump light is launched into the substrate and the outputs of the waveguides 101, 1310 are combined with the coherent coupler 1330 to form a single coherently combined output. By using a planar substrate, it may be easier to ensure that the outputs remain in phase.

Although the figures and embodiments herein have been described with reference to an optical fibre comprising sapphire, the optical fibre can comprise any suitable material in place of sapphire, and the invention extends to such embodiments. For example, instead of sapphire, a crystal material may be used e.g. a crystal fibre, such as a single-crystal fibre. Any suitable material may be used as described herein.

Various changes and alterations can be made without departing from the broader aspects and spirit of the invention. Any value or range provided may be substituted for another in order to achieve the desired results. Where the singular is used (for example ‘an’, ‘a’, ‘the’, ‘this’), it is taken be one or more items. Where the word ‘comprising’ is used, it is taken to include the succeeding method steps and/or elements, but may also include additional method steps and/or elements. The steps described in the methods herein may be carried out in any order or simultaneously. Individual steps or groups of steps may be removed from any of the methods without losing the desired effect. Individual elements or groups of elements may be removed from any of the apparatus without losing the desired effect. Parts of any of the examples may be combined with parts of any other examples in order to gain advantage. Where an element or step is stated to be optional, it should not be taken to imply that other elements or steps are essential. The skilled person will understand that any combination of features is possible within the scope of the invention, as claimed.

1. A method of stimulating emission of light, comprising using a single-mode sapphire optical waveguide as a gain medium.

2. The method as claimed in claim 1, comprising using the single-mode sapphire optical waveguide as a gain medium to amplify signal light, and/or to generate laser light.

3. (canceled)

4. The method as claimed in claim 1, comprising fabricating a Bragg grating within the single-mode sapphire optical waveguide, and/or providing opposed Bragg gratings within the single-mode sapphire optical waveguide to thereby form an optical cavity.

5. (canceled)

6. The method as claimed in claim 1, comprising using the single-mode sapphire optical waveguide as part of a sensor system.

7. The method as claimed in claim 1, wherein the single-mode sapphire optical waveguide is a depressed cladding waveguide.

8. The method as claimed in claim 1, comprising fabricating the single-mode sapphire optical waveguide using laser modification and adaptive optics aberration compensation.

9. The method as claimed in claim 1, comprising providing the single-mode sapphire optical waveguide within a sapphire optical fibre, and using the sapphire optical fibre as a multimode waveguide while simultaneously using the single-mode sapphire optical waveguide as a single-mode waveguide.

10. The method as claimed in claim 1, comprising fabricating cladding within a sapphire optical fibre to form laser-modified cladding about an optical core, the optical core and the cladding thereby co-operating to provide the single-mode sapphire optical waveguide, optionally wherein the cladding is a first cladding, the method comprising fabricating a second cladding about the first cladding.

11. (canceled)

12. The method as claimed in claim 1, comprising doping a sapphire optical fibre to form a doped region therein and fabricating the optical core of the single-mode sapphire optical waveguide within the doped region.

13. The method as claimed in claim 1, comprising fabricating the single-mode sapphire optical waveguide off-centre within a sapphire optical fibre, and/or fabricating the single-mode sapphire optical waveguide comprising an asymmetric feature.

14. (canceled)

15. The method as claimed in claim 1, comprising coupling a pump laser to the single-mode sapphire optical waveguide.

16. A sapphire optical device comprising an optical gain medium comprising a single-mode sapphire optical waveguide.

17. The sapphire optical device as claimed in claim 16, comprising a Bragg grating, optionally comprising opposed Bragg gratings providing an optical cavity for a laser system.

18. (canceled)

19. The sapphire optical device as claimed in claim 16, wherein the single-mode sapphire optical waveguide is a depressed cladding waveguide, and/or wherein the sapphire optical device is a laser-modified sapphire optical fibre; and/or
wherein the sapphire optical device is a multimode sapphire optical fibre, and the single-mode sapphire optical waveguide is disposed within the multimode fibre.

20-21. (canceled)

22. The sapphire optical device as claimed in claim 16, comprising a doped region, and wherein the optical core of the single-mode sapphire optical waveguide is within the doped region.

23. The sapphire optical device as claimed in claim 16, wherein the single-mode waveguide is off-centre within the optical device.

24. The sapphire optical device as claimed in claim 16, wherein the single-mode sapphire optical waveguide comprises laser-fabricated cladding surrounding an optical core, optionally wherein the laser-fabricated cladding is a first cladding, and the optical device comprises a second laser-fabricated cladding surrounding the first cladding.

25. (canceled)

26. A laser system for generating laser light comprising the optical device of claim 16, wherein the optical device is the gain medium of the laser system.

27. An optical amplifier comprising the optical device as claimed in claim 16.

28. A sensor system comprising the optical device as claimed in claim 16.
